(19) United States
(12) Patent Application Publication
(10) Pub. No.: US 2026/0323579 A1
(43) Pub. Date: Oct. 15, 2026

(54) INFORMATION PROCESSING METHOD AND APPARATUS, AND COMMUNICATION DEVICE, COMMUNICATION SYSTEM AND STORAGE MEDIUM

(71) Applicant: Beijing Xiaomi Mobile Software Co., Ltd., Beijing (CN)

(72) Inventor: Wei LU, Beijing (CN)

(73) Assignee: Beijing Xiaomi Mobile Software Co., Ltd., Beijing (CN)

(21) Appl. No.: 19/484,306

(22) PCT Filed: May 16, 2023
(86) PCT No.: PCT/CN2023/094625

§ 371 Date: Nov. 13, 2025

(51) Int. Cl. H04W 64/00; H04W 12/04; H04W 84/06

(52) U.S. Cl. CPC H04W 64/00; H04W 12/04; H04W 84/06

(57) ABSTRACT

An information processing method includes: sending a first request message to a first network device, where the first request message includes: identity information of the first terminal, first identity information and a service identity of a ranging/sidelink (SL) positioning service, and the first identity information is used to indicate a Public Land Mobile Network (PLMN) where a second terminal is located. The first request message is used to request a key for protecting at least one of a broadcast message or a groupcast message of the ranging/SL positioning service.

### CROSS REFERENCE TO RELATED APPLICATION

The present application is a U.S. National Stage of International Application No. PCT/CN 2023/094625, filed on May 16, 2023, the contents of which are incorporated herein by reference in its entirety.

### TECHNICAL FIELD

The present disclosure relates to the communication technical field, and in particular to an information processing method and apparatus, a communication device, a communication system, and a storage medium.

### BACKGROUND

With the continuous development of wireless communication technologies, various networks can realize more and more functions; the ranging/sidelink (SL) positioning service has become an important research topic.

### SUMMARY

According to a first aspect of an embodiment of the present disclosure, an information processing method is provided. The method is performed by a first terminal.

The method includes: sending a first request message to a first network device, where the first request message includes identity information of the first terminal, first identity information and a service identity of a ranging/SL positioning service, the first identity information is used to indicate a Public Land Mobile Network (PLMN) where a second terminal is located, and the first request message is used to request a key for protecting at least one of a broadcast message or a groupcast message of the ranging/SL positioning service.

According to a second aspect of an embodiment of the present disclosure, an information processing method is provided. The method is performed by a first network device. The method includes: receiving a first request message sent from a first terminal, where the first request message includes identity information of the first terminal, first identity information and a service identity of a ranging/SL positioning service, the first identity information is used to indicate a PLMN where a second terminal is located, and the first request message is used to request a key for protecting at least one of a broadcast message or a groupcast message of the ranging/SL positioning service.

According to a third aspect of an embodiment of the present disclosure, an information processing method is provided. The method is performed by a second terminal. The method includes: sending first information, where the first information includes first identity information, a service identity of a ranging/SL positioning service and second information, the second information is at least one of a broadcast message or groupcast message protected using a key, and the first identity information is used to indicate a PLMN where a second terminal is located.

According to a fourth aspect of an embodiment of the present disclosure, an information processing method is provided. The method is performed by a second network device. The method includes: receiving a second request message sent from a first network device, where the second request message includes identity information of a first terminal and a service identity of a ranging/SL positioning service, and the second request is used to request a key; and sending a second response message to the first network device, where the second response message includes the key.

According to a fifth aspect of an embodiment of the present disclosure, an information processing method is proposed. The method is performed by a communication system. The communication system includes terminals and network devices. The terminals include a first terminal and a second terminal. The network devices include a first network device, a second network device and a UDM. The information processing method includes: sending, by the first terminal, a first request message to the first network device, where the first request message includes identity information of the first terminal, first identity information and a service identity of a ranging/SL positioning service, the first identity information is used to indicate a PLMN where the second terminal is located, and the first request message is used to request a key for protecting at least one of a broadcast message or a groupcast message of the ranging/SL positioning service; determining, by the first network device, that a network device corresponding to the second terminal is the second network device based on the first identity information; sending, by the first network device, a second request message to the second network device, where the second request message includes the identity information of the first terminal and the service identity, and the second request message is used to request the key; sending, by the second network device, a second response message to the first network device, where the second response message includes the key; and sending, by the first network device, a first response message to the first terminal, where the first response message includes the key.

According to a sixth aspect of an embodiment of the present disclosure, a first information processing apparatus is provided. The apparatus includes: a first sending module configured to send a first request message to a first network device, where the first request message includes identity information of a first terminal, first identity information and a service identity of a ranging/SL positioning service, the first identity information is used to indicate a PLMN where a second terminal is located, and the first request message is used to request a key for protecting at least one of a broadcast message or a groupcast message of the ranging/SL positioning service.

According to a seventh aspect of an embodiment of the present disclosure, a second information processing apparatus is provided. The apparatus includes: a second receiving module configured to receive a first request message sent from a first terminal, where the first request message includes identity information of the first terminal, first identity information and a service identity of a ranging/SL positioning service, the first identity information is used to indicate a PLMN where a second terminal is located, and the first request message is used to request a key for protecting at least one of a broadcast message or a groupcast message of the ranging/SL positioning service.

According to an eighth aspect of an embodiment of the present disclosure, a third information processing apparatus is provided. The apparatus includes: a third sending module configured to send first information, where the first information includes first identity information, a service identity of a ranging/SL positioning service and second information, the second information is a broadcast message and/or groupcast message protected using a key, and the first identity information is used to indicate a PLMN where a second terminal is located.

According to a ninth aspect of an embodiment of the present disclosure, a fourth information processing apparatus is provided. The apparatus includes: a fourth receiving module configured to receive a second request message sent from a first network device, where the second request message includes identity information of a first terminal and a service identity of a ranging/SL positioning service, and the second request is used to request a key; and a fourth sending module configured to send a second response message to the first network device, where the second response message includes the key.

According to a tenth aspect of an embodiment of the present disclosure, a communication device is provided. The communication device includes: one or more processors; the processor(s) is(are) configured to invoke computer instructions to cause the communication device to perform the information processing method described in the first aspect, the second aspect, the third aspect, the fourth aspect, the fifth aspect, or an optional implementation of the first aspect, the second aspect, the third aspect, the fourth aspect and the fifth aspect.

According to an eleventh aspect of an embodiment of the present disclosure, an information processing system is provided. The system includes: a first terminal, a second terminal, a first network device, and a second network device. The first terminal is configured to perform the information processing method described in an optional implementation of the first aspect, the first network device is configured to perform the information processing method described in an optional implementation of the second aspect, the second terminal is configured to perform the information processing method described in an optional implementation of the third aspect, and the second network device is configured to perform the information processing method described in an optional embodiment of the fourth aspect.

According to a twelfth aspect of an embodiment of the present disclosure, a storage medium is provided. The storage medium stores instructions. When the instructions are run on a communication device, the communication device is caused to perform the information processing method described in the first aspect, the second aspect, the third aspect, the fourth aspect, the fifth aspect, or an optional implementation of the first aspect, the second aspect, the third aspect, the fourth aspect, and the fifth aspect.

### BRIEF DESCRIPTION OF THE DRAWINGS

In order to more clearly illustrate the technical solutions in the embodiments of the present disclosure, the following drawings required for describing the embodiments are introduced. The following drawings are merely a part of embodiments of the present disclosure and do not impose specific limitations on the protection scope of the present disclosure.

FIG. 1 is a schematic structural diagram of an information processing system according to an embodiment of the present disclosure.

FIG. 2 is an interactive schematic diagram of an information processing method according to an embodiment of the present disclosure.

FIG. 3A is a schematic flowchart of an information processing method according to an embodiment of the present disclosure.

FIG. 3B is a schematic flowchart of an information processing method according to an embodiment of the present disclosure.

FIG. 3C is a schematic flowchart of an information processing method according to an embodiment of the present disclosure.

FIG. 4A is a schematic flowchart of an information processing method according to an embodiment of the present disclosure.

FIG. 4B is a schematic flowchart of an information processing method according to an embodiment of the present disclosure.

FIG. 4C is a schematic flowchart of an information processing method according to an embodiment of the present disclosure.

FIG. 5A is a schematic flowchart of an information processing method according to an embodiment of the present disclosure.

FIG. 5B is a schematic flowchart of an information processing method according to an embodiment of the present disclosure.

FIG. 5C is a schematic flowchart of an information processing method according to an embodiment of the present disclosure.

FIG. 6A is a schematic flowchart of an information processing method according to an embodiment of the present disclosure.

FIG. 6B is a schematic flowchart of an information processing method according to an embodiment of the present disclosure.

FIG. 7 is a schematic flowchart of an information processing method according to an embodiment of the present disclosure.

FIG. 8 is a schematic flowchart of an information processing method according to an embodiment of the present disclosure.

FIG. 9A is a schematic structural diagram of an information processing apparatus according to an embodiment of the present disclosure.

FIG. 9B is a schematic structural diagram of an information processing apparatus according to an embodiment of the present disclosure.

FIG. 9C is a schematic structural diagram of an information processing apparatus according to an embodiment of the present disclosure.

FIG. 9D is a schematic structural diagram of an information processing apparatus according to an embodiment of the present disclosure.

FIG. 10A is a schematic structural diagram of a communication device according to an embodiment of the present disclosure.

FIG. 10B is a schematic structural diagram of a chip according to an embodiment of the present disclosure.

### DETAILED DESCRIPTION

The embodiments of the present disclosure need to solve the problem of obviating the need for a network function that provides a key for a broadcast/groupcast message to contact multiple peer second network device functions in different PLMNs in a case of inter-PLMN.

The embodiments of the present disclosure provide an information processing method and apparatus, a communication device, a communication system, and a storage medium.

In a first aspect, an embodiment of the present disclosure provides an information processing method. The method is performed by a first terminal. The method includes: sending a first request message to a first network device, where the first request message includes identity information of the first terminal, first identity information and a service identity of a ranging/SL positioning service, the first identity information is used to indicate a PLMN where a second terminal is located, and the first request message is used to request a key for protecting a broadcast message and/or a groupcast message of the ranging/SL positioning service.

In the above embodiment, the first terminal sends the first request message to the first device, and the first request message includes information for indicating a PLMN where the second terminal is located. This is advantageous for the first network device to determine the PLMN where the second terminal is located, and obtain the key for protecting the broadcast message and/or groupcast message of the ranging/SL positioning service based on the PLMN where the second terminal is located. In this way, the embodiment eliminates the need to obtain the key from multiple PLMNs, simplifies the operation of obtaining the key, and reduces the power consumption of the terminal, and so on.

In combination with some embodiments of the first aspect, in some embodiments, the first identity information is used to determine a second network device in the PLMN.

The above embodiments are beneficial for the first network device to obtain the key from the second network device in the PLMN where the second terminal is located, without having to obtain the key from second network devices (such as PKMF, etc.) in multiple PLMNs. The embodiments can determine the specific network element for obtaining the key and simplify the operation of obtaining the key.

In combination with some embodiments of the first aspect, in some embodiments, before sending the first request message to the first network device, the method includes: receiving first information sent from the second terminal, where the first information includes: the first identity information, the service identity of the ranging/SL positioning service and second information, and the second information is the broadcast message and/or the groupcast message protected using the key.

In the above embodiments, the key is obtained only when the first information from the second terminal is received, so as to be able to decrypt the broadcast message and/or the groupcast message protected using the key in the first information, etc.

In combination with some embodiments of the first aspect, in some embodiments, the first identity information includes one of the following: a PLMN identity of the second terminal; a second identity, including the PLMN identity, where the second identity is used to identify the second terminal; an anonymous identity, including the PLMN identity, where the anonymous identity is used to identify the second terminal and is anonymous; or a random identity including a random number and the PLMN identity, where the random identity is used to identify the second terminal.

In the above embodiments, multiple identities for indicating the PLMN where the second terminal is located are provided to adapt to more application scenarios.

In combination with some embodiments of the first aspect, in some embodiments, the first request message includes at least one of the following: first indication information used to indicate that the first terminal serves as a receiver of the broadcast message and/or the groupcast message; or a first group identity used to indicate a group to which the first terminal belongs.

In the above embodiments, the first request message further includes the first indication information and/or the first group identity, which is conducive to implementing authorization authentication of the first terminal.

In combination with some embodiments of the first aspect, in some embodiments, the method further includes: receiving a first response message sent from the first network device, where the first response message includes the key.

In the above embodiments, the first terminal can obtain the key, which is conducive to decrypting the broadcast message and/or the groupcast message protected using the key.

In a second aspect, an embodiment of the present disclosure provides an information processing method. The method is performed by a first network device. The method includes: receiving a first request message sent from a first terminal, where the first request message includes: identity information of the first terminal, first identity information, and a service identity of a ranging/SL positioning service, the first identity information is used to indicate a PLMN where a second terminal is located, and the first request message is used to request a key for protecting a broadcast message and/or a groupcast message of the ranging/SL positioning service.

In combination with some embodiments of the second aspect, in some embodiments, the first identity information includes one of the following: a PLMN identity of the second terminal; a second identity, including the PLMN identity, where the second identity is used to identify the second terminal; an anonymous identity, including the PLMN identity, where the anonymous identity is used to identify the second terminal and is anonymous; a random identity including a random number and the PLMN identity, where the random identity is used to identify the second terminal.

In combination with some embodiments of the second aspect, in some embodiments, the method further includes: determining that a network device corresponding to the second terminal is a second network device based on the first identity information.

In the above embodiments, the first network device can accurately determine, based on the first identity information, the second network device from which the key is requested.

In combination with some embodiments of the second aspect, in some embodiments, determining that the network device corresponding to the second terminal is the second network device based on the first identity information, includes: in a case that the first terminal is authorized to perform the ranging/SL positioning service, determining that the network device corresponding to the second terminal is the second network device based on the first identity information.

In the above embodiment, the second network device is determined only in a case that the first terminal can be authorized to perform the ranging/SL positioning service, thereby saving the power consumption of the first network device, etc.

In combination with some embodiments of the second aspect, in some embodiments, the method further includes: sending a second request message to the second network device, where the second request message includes the identity information of the first terminal and the service identity, and the second request message is used to request the key.

In the above embodiments, the first network device can obtain the key only from the second network device in the PLMN where the second terminal is located, which can reduce the complexity of obtaining the key and lower power consumption.

In combination with some embodiments of the first aspect, in some embodiments, the method further includes: receiving a second response message sent from the second network device, where the second response message includes the key.

In combination with some embodiments of the second aspect, in some embodiments, the method further includes: sending a first response message to the first terminal, where the first response message includes the key.

In a third aspect, an embodiment of the present disclosure provides an information processing method. The method is performed by a second terminal. The method includes: sending first information, where the first information includes first identity information, a service identity of a ranging/SL positioning service, and second information, the second information is a broadcast message and/or groupcast message protected using a key, and the first identity information is used to indicate a PLMN where the second terminal is located.

In combination with some embodiments of the third aspect, in some embodiments, the first identity information is used to determine a second network device in the PLMN.

In combination with some embodiments of the third aspect, in some embodiments, the first identity information includes one of the following: a PLMN identity of the second terminal; a second identity, including the PLMN identity, where the second identity is used to identify the second terminal; an anonymous identity, including the PLMN identity, where the anonymous identity is used to identify the second terminal and is anonymous; or a random identity including a random number and the PLMN identity, where the random identity is used to identify the second terminal.

In combination with some embodiments of the third aspect, in some embodiments, before sending the first information, the method further includes: sending a third request message to the second network device, where the third request message includes identity information of the second terminal and the service identity, and the third request message is used to request the key; and receiving a third response message sent from the second network device, where the third response message includes the key.

In the above embodiments, the second terminal can obtain the key from the second network device, which is conducive to protecting the broadcast message and/or the groupcast message.

In combination with some embodiments of the third aspect, in some embodiments, the third request message includes at least one of the following: second indication information used to indicate that the second terminal serves as a receiver of the broadcast message and/or the groupcast message; or a second group identity used to indicate a group to which the second terminal belongs.

In the above embodiments, the third request message includes the second indication information and/or the second group identity, which is conducive to implementing authorization and authentication of the second terminal.

In a fourth aspect, an embodiment of the present disclosure provides an information processing method. The method is performed by a second network device. The method includes: receiving a second request message sent from a first network device, where the second request message includes identity information of a first terminal and a service identity of a ranging/sidelink (SL) positioning service, and the second request is used to request a key; and sending a second response message to the first network device, where the second response message includes the key.

In combination with some embodiments of the fourth aspect, in some embodiments, before receiving the second request message sent from the first network device, the method further includes: receiving a third request message sent from a second terminal, where the third request message includes identity information of the second terminal and the service identity, and the third request message is used to request the key; and sending a third response message to the second terminal, where the third response message includes the key.

In combination with some embodiments of the fourth aspect, in some embodiments, the method further includes: determining the key in a case that the second terminal is authorized to perform the ranging/SL positioning service.

In the above embodiments, the second network device can accurately determine the key associated with the ranging/SL positioning service, thereby improving the security of the communication.

In a fifth aspect, an embodiment of the present disclosure provides an information processing method. The method is performed by a communication system. The communication system includes terminals and network devices, the terminals include a first terminal and a second terminal, and the network devices include a first network device, a second network device, and a UDM. The information processing method includes: sending, by the first terminal, a first request message to the first network device, where the first request message includes: identity information of the first terminal, first identity information, and a service identity of a ranging/SL positioning service, the first identity information is used to indicate a PLMN where the second terminal is located, and the first request message is used to request a key for protecting a broadcast message and/or a groupcast message of the ranging/SL positioning service; determining, by the first network device, that a network device corresponding to the second terminal is the second network device based on the first identity information; sending, by the first network device, a second request message to the second network device, where the second request message includes the identity information of the first terminal and the service identity, and the second request message is used to request the key; sending, by the second network device, a second response message to the first network device, where the second response message includes the key; and sending, by the first network device, a first response message to the first terminal, where the first response message includes the key.

In combination with some embodiments of the fifth aspect, in some embodiments, before the first terminal sends the first request message to the first network device, the method includes: sending, by the second terminal, first information to the first terminal, where the first information includes the first identity information, the service identity and second information, and the second information is the broadcast message and/or the groupcast message protected using the key.

In the sixth aspect, an embodiment of the present disclosure proposes a first information processing apparatus. The apparatus includes: a first sending module configured to send a first request message to a first network device, where the first request message includes identity information of a first terminal, first identity information and a service identity of a ranging/SL positioning service, the first identity information is used to indicate a PLMN where a second terminal is located, and the first request message is used to request a key for protecting a broadcast message and/or groupcast message of the ranging/SL positioning service.

In a seventh aspect, an embodiment of the present disclosure provides a second information processing apparatus. The apparatus includes: a second receiving module configured to receive a first request message sent from a first terminal, where the first request message includes identity information of the first terminal, first identity information and a service identity of a ranging/SL positioning service, the first identity information is used to indicate a PLMN where a second terminal is located, and the first request message is used to request a key for protecting a broadcast message and/or groupcast message of the ranging/SL positioning service.

In an eighth aspect, an embodiment of the present disclosure provides a third information processing apparatus. The apparatus includes: a third sending module configured to send first information, where the first information includes first identity information, a service identity of a ranging/SL positioning service, and second information, the second information is a broadcast message and/or groupcast message protected using a key, and the first identity information is used to indicate a PLMN where a second terminal is located.

In a ninth aspect, an embodiment of the present disclosure provides a fourth information processing apparatus. The apparatus includes: a fourth receiving module configured to receive a second request message sent from a first network device, where the second request message includes identity information of the first terminal and a service identity of a ranging/SL positioning service, and the second request is used to request a key; and a fourth sending module configured to send a second response message to the first network device, where the second response message includes the key.

In a tenth aspect, an embodiment of the present disclosure provides a communication device, including: one or more processors; the processor(s) is(are) configured to invoke computer instructions to cause the communication device to perform the information processing method described in the first aspect, the second aspect, the fourth aspect, the fifth aspect, or an optional implementation of the first aspect, the second aspect, the third aspect, the fourth aspect, and the fifth aspect.

In an eleventh aspect, an embodiment of the present disclosure proposes an information processing system. The system includes: a first terminal, a second terminal, a first network device, and a second network device. The first terminal is configured to perform the information processing method described in the optional implementation of the first aspect. The first network device is configured to perform the information processing method described in the optional implementation of the second aspect. The second terminal is configured to perform the information processing method described in the optional implementation of the third aspect. The second network device is configured to perform the information processing method described in the optional embodiment of the fourth aspect.

In a twelfth aspect, an embodiment of the present disclosure proposes a storage medium storing instructions. When the instructions are run on a communication device, the communication device is caused to perform the information processing method as described in the first aspect, the second aspect, the third aspect, the fourth aspect, or the fifth method, or an optional implementation of the first aspect, the second aspect, the third aspect, the fourth aspect and the fifth aspect.

In a thirteenth aspect, an embodiment of the present disclosure proposes a program product. When the program product is executed by a communication device, the communication device is caused to perform the information processing method described in the first aspect, the second aspect, the third aspect, the fourth aspect, or the fifth method, or an optional implementation of the first aspect, the second aspect, the third aspect, the fourth aspect and the fifth aspect.

In a fourteenth aspect, an embodiment of the present disclosure proposes a computer program. When the computer program is run on a computer, the computer is caused to perform the information processing method described in the first aspect, the second aspect, the third aspect, the fourth aspect, or the fifth method, or an optional implementation of the first aspect, the second aspect, the third aspect, the fourth aspect, and the fifth aspect.

It can be understood that the first information processing apparatus, the second information processing apparatus, the third information processing apparatus, the fourth information processing apparatus, the communication device, the communication system, the storage medium, the program product, and the computer program are all used to perform the methods provided by the embodiments of the present disclosure. Therefore, regarding the beneficial effects that can be achieved, reference can be made to the beneficial effects of the corresponding methods, and repeated descriptions will be omitted here.

The present disclosure provides an information processing method and apparatus, a communication device, a communication system, and a storage medium. In some embodiments, terms such as information processing method and communication method, etc. are interchangeable, terms such as information processing apparatus and communication apparatus, etc. are interchangeable, and terms such as information processing system and communication system, etc. are interchangeable.

The embodiments of the present disclosure are not exhaustive and are merely illustrative of a part of embodiments, and are not intended to be a specific limitation on the scope of protection of the present disclosure. Each step in a certain embodiment may be implemented as an independent embodiment, and steps may be arbitrarily combined if such a combination will not result in contradiction. For example, a solution after removing a part of the steps in a certain embodiment may also be implemented as an independent embodiment, and the order of steps in a certain embodiment may be arbitrarily exchanged. In addition, optional implementations in a certain embodiment may be arbitrarily combined; in addition, the embodiments may be arbitrarily combined. For example, a part or all steps of different embodiments may be arbitrarily combined, and a certain embodiment may be arbitrarily combined with an optional implementation of other embodiment(s).

In respective embodiments of the present disclosure, terms and/or descriptions between the embodiments are consistent, and the terms and/or descriptions can be used interchangeably, unless otherwise specially specified or logically conflicting. Technical features in different embodiments may be combined to form new embodiments based on their inherent logical relationships.

The terms used in the embodiments of the present disclosure are only for the purpose of describing specific embodiments and are not intended to limit the present disclosure.

In the embodiments of the present disclosure, unless otherwise specified, an element expressed in the singular, such as “a” “an”, “the”, “above”, “said”, “the above-described”, “this”, etc., may mean “one and only one”, or “one or more”, “at least one”, etc. For example, when using an article such as “a”, “an”, “the”, etc. in English in translation, a noun following the article may be understood as a singular expression or a plural expression.

In the embodiments of the present disclosure, “multiple” refers to two or more.

In some embodiments, the terms “at least one of”, “one or more”, “a plurality of”, “multiple”, etc., may be used interchangeably.

In some embodiments, expressions such as “at least one of A and B”, “A and/or B”, “A in a case A, B in another case”, “A in response to a case A, B in response to another case”, etc. may include the following technical solutions depending on the situation: A in some embodiments (A is executed independently of B); B in some embodiments (B is executed independently of A); selective execution of A and B in some embodiments (A and B are selectively executed); A and B in some embodiments (both A and B are executed). The above description also applies similarly when there are more branches, such as A, B, C, etc.

In some embodiments, expressions such as “A or B”, etc. may include the following technical solutions, depending on the situation: A in some embodiments (A is executed independently of B); B in some embodiments (B is executed independently of A); selective execution of A and B in some embodiments (A and B are selectively executed). The above description also applies similarly when there are more branches, such as A, B, C, etc.

Prefixes such as “first”, “second”, etc., in embodiments of the present disclosure are only used to distinguish different description objects and do not constitute any restriction on the position, order, priority, quantity, or content, etc. of the description objects. For the statement regarding a description object, reference may be made to the description in the context of claims or embodiments, and no unnecessary restriction should be constituted due to the use of prefixes. For example, if a description object is a “field”, the ordinal numbers before the “field” in a “first field” and a “second field” do not limit the position or order between the “fields”, and “first” and “second” do not limit whether the “fields” they modify are in the same message, nor do they limit the order of the “first field” and the “second field”. For another example, if a description object is a “level”, the ordinal numbers before the “level” in a “first level” and a “second level” do not limit the priority between the “levels”. For another example, the number of description objects is not limited by the ordinal number and may be one or more. Taking “first apparatus” as an example, the number of the “apparatus” may be one or more. In addition, the objects modified by different prefixes may be the same or different. For example, if a description object is “apparatus”, then a “first apparatus” and a “second apparatus” may be the same apparatus or different apparatuses, and their types may be the same or different. For another example, if a description object is “information”, “first information” and “second information” may be the same information or different information, and their contents may be the same or different.

In some embodiments, “including/comprising A”, “containing A”, “indicating A”, and “carrying A” may be interpreted as directly carrying A or indirectly indicating A.

In some embodiments, terms such as “in response to . . . ” , “in response to determining . . . ” , “in a case that . . . ” , “at the time of . . . ” , “when . . . ” , “in a case of . . . ” , “if . . . ” , etc., may be used interchangeably.

In some embodiments, terms such as “greater than”, “greater than or equal to”, “not less than”, “more than”, “more than or equal to”, “not less than”, “higher than”, “higher than or equal to”, “not lower than”, “above”, etc. may be used interchangeably, and terms such as “smaller than”, “smaller than or equal to”, “not greater than”, “less than”, “less than or equal to”, “not more than”, “lower than”, “lower than or equal to”, “not higher than”, “below”, etc., may be used interchangeably.

In some embodiments, apparatus, etc., may be interpreted as physical or virtual, and its name is not limited to the name in the embodiments. Terms such as “apparatus”, “equipment”, “device”, “circuit”, “network element”, “node”, “function”, “unit”, “section”, “system”, “network”, “chip”, “chip system”, “entity”, “subject”, etc., may be used interchangeably.

In some embodiments, “network” may be interpreted as an apparatus included in a network (e.g., an access network device, a core network device, etc.).

In some embodiments, terms “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier”, “bandwidth part (BWP)”, etc., may be used interchangeably.

In some embodiments, the terms “terminal”, “terminal device” “User Equipment (UE)”, “user terminal”, “Mobile Station (MS)”, “Mobile Terminal (MT)”, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, etc., may be used interchangeably.

In some embodiments, an access network device, a core network device, or a network device may be replaced with a terminal. For example, a structure in which the communication between an access network device, a core network device or a network device and a terminal is replaced with communication between multiple terminals (for example, the communication may also be referred to as device-to-device (D2D), vehicle-to-everything (V2X), etc.), may also be applied in the embodiments of the present disclosure. In this case, a structure in which a terminal has all or part of the functions of an access network device may also be set. In addition, languages such as “uplink” or “downlink”, etc. may also be replaced with language corresponding to communication between terminals (for example, “side”). For example, an uplink channel, a downlink channel, etc., may be replaced with a side channel, and uplink or downlink, etc., may be replaced with a sidelink.

In some embodiments, a terminal may be replaced by an access network device, a core network device, or a network device. In this case, a structure in which the access network device, the core network device, or the network device may have all or part of the functions of the terminal may also be set.

In some embodiments, obtaining data, information, etc., may comply with the laws and regulations of the country where the data is obtained.

In some embodiments, data, information, etc., may be obtained with the user's consent.

In addition, each element, each row, or each column in a table of the embodiments of the present disclosure may be implemented as an independent embodiment, and the combination of any element(s), any row(s), and any column(s) may also be implemented as an independent embodiment.

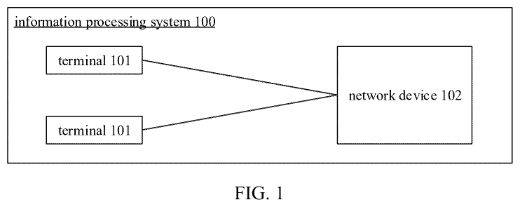

FIG. 1 is a schematic diagram of the structure of an information processing system 100 according to an embodiment of the present disclosure. As shown in FIG. 1, the information processing system 100 may include: a terminal 101 and a network device 102.

In some embodiments, the network device 102 may include at least one of an access network device and a core network device.

In some embodiments, the terminal 101 includes, for example, at least one of: a mobile phone, a wearable device, an Internet of Things device, a car with communication capabilities, a smart car, a tablet computer, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, but is not limited to the above listed examples.

In some embodiments, terminal 101 includes a first terminal and a second terminal.

In some embodiments, the access network device is, for example, a node or device that enables a terminal to access a wireless network. The access network device may include at least one of: an evolved NodeB (eNB), a next generation evolved NodeB (next generation eNB, ng-eNB) , a next generation NodeB (gNB), a node B (NB), a home node B (HNB), a home evolved nodeB (HeNB), a wireless backhaul device, a Radio Network Controller (RNC), a Base Station Controller (BSC), a Base Transceiver Station (BTS), a Base Band Unit (BBU), a mobile switching center, a base station in a 6G communication system, an open base station (Open RAN), a cloud base station (Cloud RAN), a base station in other communication systems, an access node in a Wireless Fidelity (WiFi) system, but is not limited to the above listed examples.

In some embodiments, the technical solutions of the present disclosure may be applied to the Open RAN architecture. In this case, interfaces between or within access network devices involved in the embodiments of the present disclosure may be changed into internal interfaces of Open RAN, and the processes and information interactions between these internal interfaces may be implemented through software or programs.

In some embodiments, the access network device may be formed by a Central Unit (CU) and a Distributed Unit (DU). The CU may also be referred to as a control unit. A CU-DU structure may be used to separate protocol layers of the access network device, with functions of some of the protocol layers centrally controlled by the CU and functions of the remaining part or all protocol layers distributed in the DU, and DU(s) is(are) centrally controlled by the CU, but is not limited thereto.

In some embodiments, a core network device may be a single device including a first network element, a second network element, etc., or may be multiple devices or a device group including all or part of the first network element and the second network element. The network element may be virtual or physical. The core network may include, for example, at least one of: an Evolved Packet Core (EPC), a 5G Core Network (5GCN), a Next Generation Core (NGC).

In some embodiments, the first network element may be a Proximity Service Key Management Function (PKMF), and the name is not limited to PKMF.

In some embodiments, the first network element is used for key management.

In some embodiments, the second network element may be a User Data Management (UDM) function, and the name is not limited to UDM.

In some embodiments, the second network element is used to authorize a ranging/SL positioning service of a terminal.

It can be understood that the information processing system described in the embodiments of the present disclosure is for the purpose of more clearly illustrating the technical solutions of the embodiments of the present disclosure, and does not constitute a limitation on the technical solutions provided by the embodiments of the present disclosure. Those of ordinary skill in this art can know that with the evolution of system architecture and the emergence of new service scenarios, the technical solutions provided by the embodiments of the present disclosure are also applicable to similar technical problems.

The following embodiments of the present disclosure may be applied to the information processing system 100 shown in FIG. 1, or a part of the entities, but are not limited thereto. The entities shown in FIG. 1 are illustrative only. The information processing system may include all or a part of the entities shown in FIG. 1, or may include other entities than those shown in FIG. 1. The number and form of the entities may be arbitrary. The connection relationships between the entities are illustrative only. The entities may be connected or not, and their connection may be in any manner, including direct or indirect connection, and their connection may be wired or wireless.

The embodiments of the present disclosure may be applied to: Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G New Radio (NR), Future Radio Access (FRA), New-Radio Access Technology (RAT), New Radio (NR), New Radio Access (NX), Future Generation Radio Access (FX), Global System for Mobile communications (GSM (registered trademark)), CDMA2000, Ultra Mobile Broadband (UMB), IEEE 802.11 (Wi-Fi) (registered trademark)), IEEE 802.16 (WiMAX (registered trademark)), IEEE 802.20, Ultra-WideBand (UWB), Bluetooth (registered trademark), Public Land Mobile Network (PLMN) network, Device-to-Device (D2D) system, Machine-to-Machine (M2M) system, Internet of Things (IOT) system, Vehicle-to-Everything (V2X), system(s) utilizing other communication method(s), next-generation system(s) based on the above, etc. Furthermore, a combination of multiple systems (for example, a combination of LTE or LTE-A with 5G, etc.) may also be employed.

In some embodiments, for the security aspect of current ranging/SL positioning services, there is a key issue on the security protection of broadcast/groupcast Sidelink Positioning Protocol (SLPP) signaling. The signaling may include, for example, SL positioning capability, SL positioning assistance data, location information, etc. As SL positioning capability and SL positioning assistance data are information used to obtain a ranging result (i.e., location information), they should be integrity-protected against tampering. The SL positioning capability and location information concern the privacy of an involved UE and they should be encrypted to preserve the privacy of the UE. Therefore, in order to enable SLPP signaling broadcast/groupcast with security protection, there is a need to study a method to protect the SL positioning signaling which is broadcasted/groupcasted by a ranging/SL positioning capable UE.

In some implementations, there are currently various solutions for protecting broadcasted/groupcasted SLPP signaling, most of which do not support an inter-PLMN scenario. Among solutions supporting inter-PLMN, the solutions may rely on information of groupcasting UE (including a PLMN ID) returned by an application server; or the solutions may be designed for service-agnostic broadcasting of SLPP signaling; or the solutions may rely on Sidelink Positioning Broadcast Key Identity Information (Sidelink Positioning broadcast key Identifier, SLPBK-ID) (including PLMN ID).

In some embodiments, an application server may provide information of multiple groupcasting UEs, possibly including different PLMN IDs. Therefore, a Direct Discovery Name Management Function (DDNMF) or PKMF needs to contact multiple DDNMFs or PKMFs in different PLMNs and retrieve multiple sets of groupcast keys, resulting in a waste of resources when only one set of keys can be used. Therefore, this solution is suitable for service-agnostic broadcasting of SLPP signaling, but this is not optimal for service-specific broadcasting of SLPP signaling.

In some embodiments, the network generates and provides the UE with an SLPBK-ID, which is sent in plain text in a broadcast message. Therefore, there is a risk that an attacker can track the UE by capturing the same SLPBK-ID in consecutive broadcast messages.

In some embodiments, for ranging/SL positioning services, each pair of UEs needs to discover each other to establish unicast communication between them for exchanging ranging/SL positioning signaling. The discovery message is broadcasted by a UE, and the security of the discovery message is protected by discovery security material provided by the network. When the ranging/SL positioning signaling is broadcasted, there is no need to establish a unicast connection, and therefore there is no need to perform discovery between UEs. However, the procedure for obtaining discovery security material from the network can be adapted to obtain key(s) for protecting the broadcast ranging/SL positioning signaling.

In some embodiments, when some UEs need to broadcast/groupcast SL positioning signaling, and some UEs need to receive SL positioning signaling, they normally perform broadcasting/groupcasting and reception for the same ranging/SL positioning service. Otherwise, when a UE expecting service A receives broadcast SL positioning signaling for service B, the broadcast/groupcast signaling (e.g., positioning assistance information) may be of no use to the receiving UE, and the information of the broadcasting/groupcasting UE of service A is unnecessarily exposed to the receiving UE for service B, leading to privacy issues. Therefore, when shared keys for broadcast are generated, the keys should be bound with a specific ranging/SL positioning service (indicated by a service ID).

Generally, a UE may also be referred to as a terminal.

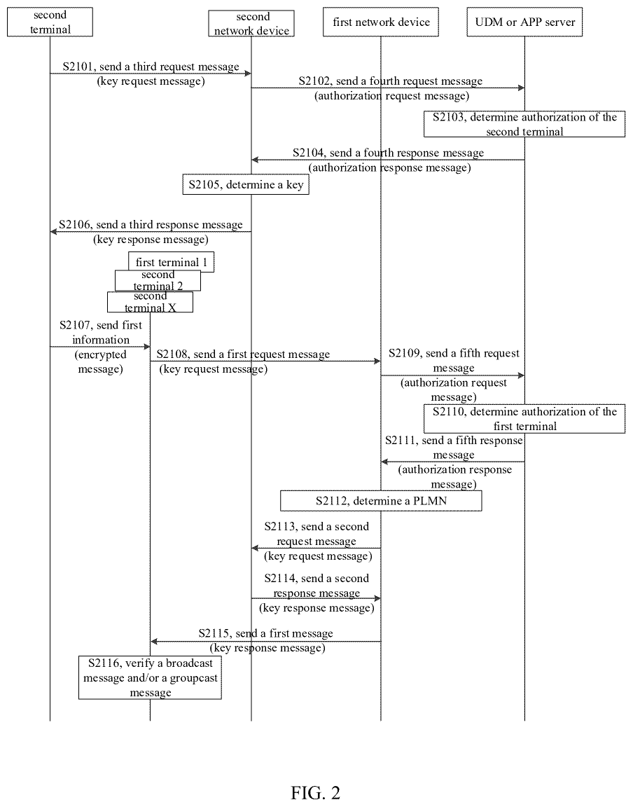

FIG. 2 is an interactive schematic diagram of an information processing method according to an embodiment of the present disclosure. As shown in FIG. 2, the embodiment of the present disclosure relates to an information processing method applied in the information processing system 100. The method includes the following steps.

In step S2101, a second terminal sends a third request message to a second network device.

In some embodiments, the second network device receives the third request message sent from the second terminal.

In some embodiments, the second terminal is a receiver, such as an R-UE.

In some embodiments, the second network device is a PKMF of the receiver, for example, the first network element in the above embodiment, or a PKMF of the R-UE.

In some embodiments, the third request message is used to request a key. Optionally, the key is associated with a ranging/SL positioning service. Optionally, the key is used to protect a broadcast message and/or a groupcast message of the ranging/SL positioning service indicated by a service identity. Optionally, the key is used for at least one of encryption or integrity protection of the broadcast message and/or groupcast message.

In some embodiments, the name of the third request message is not limited. For example, the name of the third request message may be a key request message, or an SLPP broadcast or groupcast key request, etc.

In some embodiments, the third request message includes at least one of identity information of the second terminal, the service identity of the ranging/SL positioning service, second indication information or a second group identity.

In some embodiments, the identity information of the second terminal is used to identify the second terminal. Optionally, the identity information of the second terminal may be any number or index, or character string, etc., that identifies the second terminal.

In some embodiments, the service identity is used to indicate the ranging/SL positioning service. Optionally, the service identity may be any number or index, or character string, etc., that identifies the ranging/SL positioning service. Optionally, the service identity may be a service code. Optionally, different ranging/SL positioning services may correspond to different service identities or service codes.

In some embodiments, the name of the second indication information is not limited. For example, the name of the second indication information may be role information, etc.

In some embodiments, the second indication information is used to indicate that the second terminal serves as a sender of the broadcast message and/or the groupcast message.

In some embodiments, the second group identity is used to indicate a group to which the second terminal belongs.

In step S2102, the second network device sends a fourth request message to a UDM or an APP server.

In some embodiments, the UDM or APP server receives the fourth request message sent from the second network device. Optionally, the fourth request message is the same as the third request message. Optionally, the fourth request message is different from the third request message.

In some embodiments, the fourth request message is used to request authorization of the second terminal.

In some embodiments, the name of the fourth request message is not limited. For example, the name of the fourth request message may be an authorization request message, or an SLPP broadcast or groupcast authorization request, etc.

In some embodiments, the fourth request message includes at least one of: the identity information of the second terminal, the service identity of the ranging/SL positioning service, the second indication information or the second group identity.

In step S2103, the UDM or APP server determines the authorization of the second terminal.

In some embodiments, the UDM or APP server determines the authorization of the second terminal based on the service identity and the identity information of the second terminal. Optionally, determining the authorization of the second terminal includes: determining that authorization authentication of the first terminal is successful. Optionally, determining authorization of the second terminal includes: determining that the second terminal is authorized to perform the ranging/SL positioning service.

In some embodiments, the UDM or APP server determines that the second terminal is not authorized based on the service identity and the identity information of the second terminal. Optionally, determining that the second terminal is not authorized includes: determining that authorization authentication of the second terminal fails. Optionally, determining that the second terminal is not authorized includes: determining that the second terminal is not authorized to perform the ranging/SL positioning service.

In some embodiments, the UDM or APP server determines at least one of: the second terminal is authorized to serve as a sender of the broadcast message and/or the groupcast message, or the second terminal is authorized to perform the ranging/SL positioning service.

In step S2104, the UDM or APP server sends a fourth response message to the second network device.

In some embodiments, the second network device receives the fourth response message sent from the UDM or the APP.

In some embodiments, the fourth response message is used to respond to the authorization authentication of the second terminal.

In some embodiments, the name of the fourth response message is not limited. For example, the name of the fourth response message may be an authorization response message, or an SLPP broadcast or groupcast authorization response, etc.

In some embodiments, the fourth response message includes third indication information. Optionally, the third indication information, taking a first value, indicates that the authorization authentication of the second terminal is successful or the second terminal is authorized. Optionally, the third indication information, taking a second value, indicates that the authorization authentication of the second terminal fails or the second terminal is not authorized.

In some embodiments, the UDM or APP server sending the fourth response message to the second network device includes: in a case that the second terminal is authorized to perform the ranging/SL positioning service, sending, by the UDM or APP server, the fourth response message to the second network device. Optionally, the fourth response message includes the third indication information, and the third indication information takes the first value.

In some embodiments, in a case that the UDM or APP server determines that the second terminal is not authorized to perform the ranging/SL positioning service, the fourth response message is not sent to the second network device.

Optionally, in a case where the UDM or APP server determines that the second terminal is not authorized to perform the ranging/SL positioning service, a rejection message is sent to the second network device; the rejection message is used to prevent the second terminal from sending a broadcast message and/or a groupcast message within a predetermined time.

In step S2105, the second network device determines the key.

In some embodiments, the key is a key for the ranging/SL positioning service.

In some embodiments, the name of the key is not limited. For example, the name of the key may be an SLPP broadcast or groupcast key, etc.

In step S2106, the second network device sends a third response message to the second terminal.

In some embodiments, the second terminal receives the third response message sent from the second network device.

In some embodiments, the third response message includes the key.

In some embodiments, the name of the third response message is not limited. For example, the name of the third response message may be a key response message, or an SLPP broadcast or groupcast key response, etc.

In some embodiments, the third response message includes at least one of: a validity period of the key, the service identity, the identity information of the second terminal, or the second indication information.

In step S2107, the second terminal sends the first information.

In some embodiments, the second terminal broadcasts or groupcasts the first information.

In some embodiments, a first terminal receives the first information sent from the second terminal. Optionally, the first terminal receives the first information broadcast or groupcast by the second terminal.

In some embodiments, the first information is used to determine at least one of the following: a PLMN where the second terminal is located, or a second network device in the PLMN where the second terminal is located.

In some embodiments, the name of the first information is not limited. For example, the name of the first information may be encrypted information, etc.

In some embodiments, the first information includes at least one of: first identity information, the service identity, or second information.

In some embodiments, the first identity information is used to determine the PLMN where the second terminal is located. Optionally, the first identity information is used to determine a Home Public Land Mobile Network (HPLMN) where the second terminal is located. Optionally, the first identity information is used to determine the second network device in the PLMN.

In some embodiments, the first identity information includes at least one of: a PLMN identity (ID) of the second terminal, a second identity including the PLMN identity, an anonymous identity including the PLMN ID, or a random identity including a random number and the PLMN ID Optionally, the second identity is used to identify the second terminal. The second identity may be determined by the PLMN identity and the identity information of the second terminal. Optionally, the identity information of the second terminal may be any number or index or character string, etc., that identifies the second terminal.

Optionally, the PLMN identity may be any number or index, or a character string that identifies the PLMN.

Optionally, the anonymous identity is an identity that is anonymous and is used to identify the second terminal.

Optionally, the random identity may be generated by a random number and the PLMN ID. Optionally, the random identity may be used to identify the second terminal.

In some embodiments, the second information is the broadcast message and/or the groupcast message protected using the key.

In some embodiments, the name of the second information is not limited. For example, the name of the second information may be a groupcast key message or a broadcast key message.

In step S2108, the first terminal sends a first request message to the first network device.

In some embodiments, the second network device receives the first request message sent from the first terminal.

In some embodiments, the first terminal is a sender, for example, a broadcasting or groupcasting UE (B/G-UE).

In some embodiments, the first network device is the PKMF of the sender, for example, the first network element in the above embodiment or the PKMF of the B/G-UE.

In some embodiments, the first request message is used to request the key. Optionally, the first request message is used to request the key for protecting the broadcast message and/or the groupcast message of the ranging/SL positioning service.

In some embodiments, the name of the first request message is not limited. For example, the name of the first request message may be a key request message, or an SLPP broadcast or groupcast key request, etc.

In some embodiments, the first request message includes at least one of: identity information of the first terminal, the service identity of the ranging/SL positioning service, first identity information, first indication information, or a first group identity.

In some embodiments, the identity information of the first terminal is used to identify the first terminal. Optionally, the identity information of the first terminal may be a first identity, and the first identity may be any number or index, or character string, etc., that identifies the first terminal.

In some embodiments, the name of the first indication information is not limited. For example, the name of the first indication information may be role information, etc.

In some embodiments, the first indication information is used to indicate that the first terminal serves as a receiver of the broadcast message and/or the groupcast message.

In some embodiments, the first group identity is used to indicate a group to which the first terminal belongs.

In some embodiments, the first terminal sending the first request message to the first network device includes: receiving, by the first terminal, the first information sent from the second terminal, and sending the first request message to the first network device.

In step S2109, the first network device sends a fifth request message to the UDM or APP server.

In some embodiments, the UDM or APP server receives the fifth request message sent from the first network device. Optionally, the fifth request message is the same as the first request message. Optionally, the fifth request message is different from the first request message.

In some embodiments, the fifth request message is used to request authorization of the first terminal.

In some embodiments, the name of the fifth request message is not limited. For example, the name of the fifth request message may be an authorization request message, or an SLPP broadcast or groupcast authorization request, etc.

In some embodiments, the fifth request message includes at least one of: the identity information of the first terminal, the service identity of the ranging/SL positioning service, the first indication information or the first group identity.

In step S2110, the UDM or APP server determines the authorization of the first terminal.

In some embodiments, the UDM or APP server determines authorization of the first terminal based on the service identity and identity information of the first terminal. Optionally, determining the authorization of the first terminal includes: determining that authorization authentication of the first terminal is successful. Optionally, determining the authorization of the first terminal includes: determining that the first terminal is authorized to perform the ranging/SL positioning service.

In some embodiments, the UDM or APP server determines that the first terminal is not authorized based on the service identity and the identity information of the first terminal. Optionally, determining that the first terminal is not authorized includes: determining that authorization authentication of the first terminal fails. Optionally, determining that the first terminal is not authorized includes: determining that the first terminal is not authorized to perform the ranging/SL positioning service.

In some embodiments, the UDM or APP server determines at least one of: the first terminal is authorized to serve as a receiver of the broadcast message and/or groupcast message, or the first terminal is authorized to perform the ranging/SL positioning service.

In step S2111, the UDM or APP server sends a fifth response message to the first network device.

In some embodiments, the first network device receives the fifth response message sent from the UDM or APP server.

In some embodiments, the name of the fifth response message is not limited. For example, the name of the fifth response message may be an authorization response, or an SLPP broadcast or groupcast authorization response, etc.

In some embodiments, the fifth response message includes fourth indication information. Optionally, the fourth indication information, taking a first value, indicates that the authorization authentication of the first terminal is successful or the first terminal is authorized. Optionally, the fourth indication information, taking a second value, indicates that the authorization authentication of the first terminal fails or the first terminal is not authorized.

In some embodiments, sending, by the UDM or APP service, the fifth response message to the first network device, includes: in a case that the first terminal is authorized to perform the ranging/SL positioning service, sending, by the UDM or APP server, the fifth response message to the first network device. Optionally, the fifth response message includes the fourth indication information, which takes the first value.

In some embodiments, in a case that the UDM or APP server determines that the first terminal is not authorized to perform the ranging/SL positioning service, the fifth response message is not sent to the first network device.

In step S2112, the first network device determines the PLMN.

In some embodiments, the first network device determining the PLMN includes: determining, by the first network device, the PLMN where the second terminal is located based on the first identity information, or determining, by the first network device, the HPLMN where the second terminal is located based on the first identity information.

In some embodiments, the first network device determines a second network device corresponding to the PLMN. Optionally, the first network device determines the PLMN where the second terminal is located based on the first identity information, and based on the PLMN where the second terminal is located, determines a second network device corresponding to the PLMN where the second terminal is located.

In some embodiments, the first network device determining the PLMN includes: determining, by the first network device, the PLMN where the second terminal is located based on the first identity information in a case that the first terminal is authorized to perform the ranging/SL positioning service.

In step S2113, the first network device sends a second request message to the second network device.

In some embodiments, the second network device receives the second request message sent from the first network device.

In some embodiments, the second request message is used to request the key.

In some embodiments, the name of the second request message is not limited. For example, the name of the second request message may be a key request message, or an SLPP broadcast or groupcast key request, etc.

In some embodiments, the second request message includes at least one of: the identity information of the first terminal, the service identity of the ranging/SL positioning service, the first indication information or the first group identity.

In step S2114, the second network device sends a second response message to the first network device.

In some embodiments, the first network device receives the second response message sent from the second network device.

In some embodiments, the second response message includes the key.

In some embodiments, the name of the second response message is not limited. For example, the name of the second response message may be a key response message, or an SLPP broadcast or groupcast key response, etc.

In some embodiments, the second response message includes at least one of: a validity period of the key, the service identity, the identity information of the first terminal, or the first group identity.

In step S2115, the first network device sends a first response message to the first terminal.

In some embodiments, the first terminal receives the first response message sent from the first network device.

In some embodiments, the first response message is the same as the second response message.

In some embodiments, the first response message is different from the second response message.

In some embodiments, the first response message includes the key.

In some embodiments, the name of the first response message is not limited. For example, the name of the first response message may be a key response message, or an SLPP broadcast or groupcast key response, etc.

In some embodiments, the first response message includes at least one of: a validity period of the key, the service identity, the identity information of the first terminal, or the first group identity.

In step S2116, the first terminal verifies the broadcast message and/or groupcast message.

In some embodiments, the first terminal verifies the second information. Optionally, the second information is the broadcast message and/or groupcast message protected using the key.

In some embodiments, the first terminal verifying the broadcast message and/or the groupcast message includes at least one of the following: decrypting, by the first terminal, the second information based on the key decryption, or verifying, by the first terminal, the integrity of the second information based on the key.

In some embodiments, “obtain”, “acquire”, “get”, “receive”, “transmit”, “send and/or receive” may be interchangeable, and may be interpreted as receiving from other entities, obtaining from a protocol, obtaining by self-processing, autonomous implementation, etc.

In some embodiments, terms such as “send”, “transmit”, “report”, “issue”, “deliver”, “bidirectional transmission”, “send and/or receive”, etc., may be used interchangeably.

In some embodiments, terms such as “certain”, “predetermined”, “preset”, “set”, “indicated”, “one of”, “any”, “first”, etc., may be used interchangeably. Expressions “specific A”, “predetermined A”, “preset A”, “set A”, “indicated A”, “certain A”, “any A”, “first A”, may be interpreted as A pre-specified in a protocol, etc., or may be interpreted as A obtained through setting, configuration, or indication, etc., or may be interpreted as specific A, certain A, any A, or first A, etc., but are not limited to these.

In some embodiments, determination or judgment may be performed by a value represented by 1 bit (0 or 1), or by a true or false value (Boolean value) represented by true or false, or by comparison of numerical values (for example, comparison with a predetermined value), but is not limited thereto.

In some embodiments, “not expect to receive” may be interpreted as not receiving on a time domain resource and/or a frequency domain resource, or may be interpreted as not performing subsequent processing on data and so on after receiving it; “not expect to send” may be interpreted as not sending, or may be interpreted as sending but not expecting the recipient to respond to the content sent.

The information processing method involved in the embodiments of the present disclosure may include at least one of steps S2101 to S2116. For example, step S2112 may be implemented as an independent embodiment. A combination of step S2111 and step S2112 may be implemented as an independent embodiment. A combination of step S2111, step S2113, and step S2114 may be implemented as an independent embodiment. A combination of steps S2109, S2110, S2111, and S2112 may be implemented as an independent embodiment. Step S2118 may be implemented as an independent embodiment. A combination of step S2117 and step S2118 may be implemented as an independent embodiment. A combination of steps S2118 to S2115 may be implemented as an independent embodiment. A combination of steps S2117 to S2115 may be implemented as an independent embodiment. A combination of steps S2101 to S2116 may be implemented as an independent embodiment. A combination of steps S2112 to S2114 may be implemented as an independent embodiment. A combination of steps S2101 to S2115 may be implemented as an independent embodiment. A combination of steps S2101 to S2116 may be implemented as an independent embodiment.

In some embodiments, at least one of steps S2101 to S2106 or step S2116 may be omitted.

In some embodiments, steps S2101 to S2106 may be optional, and one or more of these steps may be omitted or replaced in different embodiments.

In some embodiments, step S2116 may be optional, and one or more of these steps may be omitted or replaced in different embodiments.

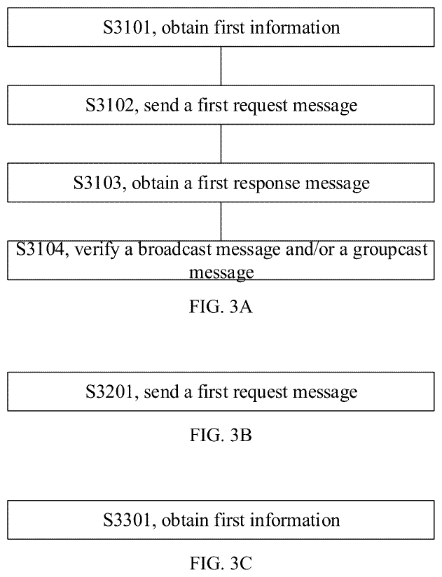

FIG. 3A is a schematic flowchart of an information processing method according to an embodiment of the present disclosure. As shown in FIG. 3A, the embodiment of the present disclosure relates to an information processing method. The method is performed by a first terminal. The method includes the following steps.

In step S3101, the first information is obtained.

Regarding the optional implementation of step S3101, reference can be made to the optional implementation of step S2107 in FIG. 2 and other related parts in the embodiments involved in FIG. 2, and repeated description will be omitted here.

In some embodiments, the first terminal receives the first information sent from the second terminal, but is not limited thereto. The first terminal may also receive the first information sent from other entities.

In some embodiments, the first terminal obtains first information specified by a protocol.

In some embodiments, the first terminal obtains the first information from a higher layer.

In some embodiments, the first terminal performs processing to obtain the first information.

In some embodiments, step S3101 is omitted, the first terminal autonomously implements the function indicated by the first information, or the above function is the default or by default.

Optionally, the first information is used for the first terminal to send the first request information.

In step S3102, a first request message is sent.

Regarding the optional implementation of step S3102, reference can be made to the optional implementation of step S2108 in FIG. 2 and other related parts in the embodiments involved in FIG. 2, and repeated description will be omitted here.

In some embodiments, the first terminal sends the first request message to the first network device, but is not limited thereto, and the first request message may also be sent to other entities.

Optionally, the first request message is used to obtain a key.

In step S3103, a first response message is obtained.

Regarding the optional implementation of step S3103, reference can be made to the optional implementation of step S2115 in FIG. 2 and other related parts in the embodiments involved in FIG. 2, and repeated description will be omitted here.

In some embodiments, the first terminal receives the first response message sent from the first network device, but the present disclosure is not limited to this. The first terminal may also receive the first information sent from other entities.

In some embodiments, the first terminal obtains the first response information specified by a protocol.

In some embodiments, the first terminal obtains the first response message from a higher layer.

In some embodiments, the first terminal performs processing to obtain the first response message.

In some embodiments, step S3103 is omitted, and the first terminal autonomously implements the function indicated by the first response message, or the above function is the default or by default.

In step S3104, a broadcast message and/or a groupcast message is verified.

In some embodiments, the first terminal verifies the broadcast message and/or a groupcast message sent from a second terminal. The broadcast message and/or the groupcast message is a message protected using a key.

In some embodiments, the first terminal verifies the first information sent from the second terminal. Optionally, the first information includes the second information.

In some embodiments, the first terminal performs at least one of: decrypting the broadcast message and/or the groupcast message, verifying the integrity of the broadcast message and/or the groupcast message, decrypting the second information, verifying the integrity of the second information, or verifying the integrity of the first information.

Regarding the optional implementation of step S3103, reference can be made to the optional implementation of step S2116 in FIG. 2 and other related parts in the embodiments involved in FIG. 2, and repeated description will be omitted here.

In some embodiments, step S3104 may be omitted.

In some embodiments, step S3101 and step S3103 may be optional, and one or more of these steps may be omitted or replaced in different embodiments.

In some embodiments, step S3102, step S3103, and step S3104 may be optional, and one or more of these steps may be omitted or replaced in different embodiments.

FIG. 3B is a schematic flowchart of an information processing method according to an embodiment of the present disclosure. As shown in FIG. 3B, the embodiment of the present disclosure relates to an information processing method. The method is performed by a first terminal. The method includes the following steps.

In step S3201, a first request message is sent.

Regarding an optional implementation of step S3201, reference can be made to optional implementations of step S2108 in FIG. 2 or step S3102 in FIG. 3A, and other related parts in the embodiments involved in FIG. 2 and FIG. 3A, and repeated descriptions will be omitted here.

Optionally, the first request message includes: identity information of the first terminal, first identity information, and a service identity of a ranging/sidelink (SL) positioning service. The first identity information is used to indicate a Public Land Mobile Network (PLMN) where a second terminal is located. The first request message is used to request a key for protecting a broadcast message and/or a groupcast message of the ranging/SL positioning service.

In some embodiments, the first identity information is used to determine a second network device in the PLMN.

In some embodiments, before sending the first request message to the first network device, the method includes: receiving first information sent from the second terminal, where the first information includes: the first identity information, the service identity, and second information, and the second information is the broadcast message and/or groupcast message protected using the key.

In some embodiments, the first identity information includes one of the following: a PLMN identity of the second terminal; a second identity including the PLMN identity; an anonymous identity including the PLMN identity; and a random identity including a random number and the PLMN identity. Optionally, the second identity may be used to identify the second terminal. Optionally, the anonymous identity may be used to identify the second terminal, and the anonymous identity is anonymous. Optionally, the random identity may be used to identify the second terminal.

In some embodiments, the first request message includes at least one of the following: first indication information used to indicate that the first terminal serves as a receiver of the broadcast message and/or the groupcast message; or a first group identity used to indicate a group to which the first terminal belongs.

In some embodiments, the method further includes: receiving a first response message sent from the first network device, where the first response message includes the key.

The above embodiments may be implemented individually or in combination with each other. For optional implementations, reference can be made to the optional implementations of the steps in FIG. 2 and FIG. 3A, and repeated descriptions will be omitted here.

FIG. 3C is a schematic flowchart of an information processing method according to an embodiment of the present disclosure. As shown in FIG. 3C, the embodiment of the present disclosure relates to an information processing method. The method is performed by a first terminal. The method includes the following steps.

In step S3301, first information is obtained.

Regarding an optional implementation of step S3301, reference can be made to the optional implementations of step S2107 in FIG. 2 or step S3101 in FIG. 3A, and other related parts in the embodiments involved in FIG. 2 and FIG. 3A, and repeated descriptions will be omitted here.

The above embodiments may be implemented individually or in combination with each other. For optional implementations, reference may be made to the optional implementations of the steps in FIG. 2 and FIG. 3A, and repeated descriptions will be omitted here.

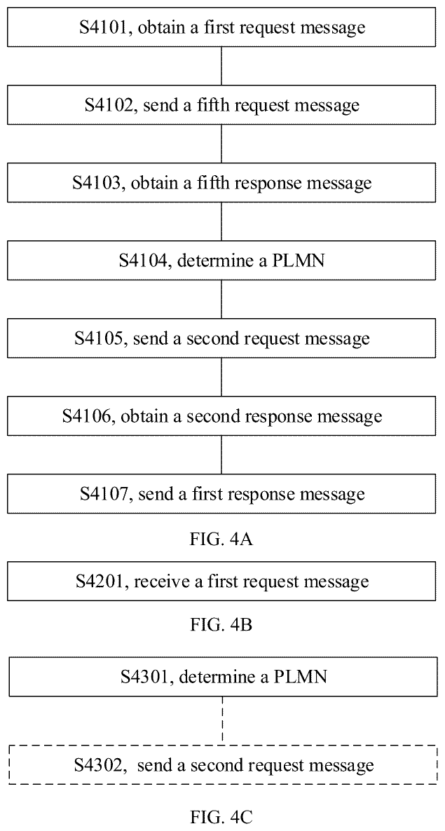

FIG. 4A is a schematic flowchart of an information processing method according to an embodiment of the present disclosure. As shown in FIG. 4A, the embodiment of the present disclosure relates to an information processing method. The method is performed by a first network device. The method includes the following steps.

In step S4101, a first request message is obtained.

Regarding an optional implementation of step S4101, reference can be made to the optional implementation of step S2108 in FIG. 2 and other related parts in the embodiments involved in FIG. 2, and repeated descriptions will be omitted here.

In some embodiments, the first network device receives the first request message sent from the first terminal, but the present disclosure is not limited to this. The first network device may also receive the first request message sent from other entities.

In some embodiments, the first network device obtains the first request message specified by a protocol.

In some embodiments, the first network device obtains the first request message from a higher layer.

In some embodiments, the first network device performs processing to obtain the first request message.

In some embodiments, step S4101 is omitted, and the first terminal autonomously implements the function indicated by the first request message, or the function is default or by default.

Optionally, the first request message includes a key.

Optionally, the first request message is used for the first network device to send a fifth request message.

In step S4102, a fifth request message is sent.

Regarding an optional implementation of step S4102, reference can be made to the optional implementations of step S2109 in FIG. 2 and other related parts in the embodiments involved in FIG. 2, and repeated descriptions will be omitted here.

In some embodiments, the first terminal sends the fifth request message to the UDM or APP server, but the present disclosure is not limited to this. The fifth request message may also be sent to other entities.

Optionally, the first request message is used to request authorization of the first terminal.

In step S4103, a fifth response message is obtained.

Regarding an optional implementation of step S4103, reference can be made to the optional implementations of step S2110 in FIG. 2 and other related parts in the embodiments involved in FIG. 2, and repeated descriptions will be omitted here.

In some embodiments, the first network device receives the fifth response message sent from the UDM or APP server, but the present disclosure is not limited to this. The first network device may also receive the fifth response message sent from other entities.

In some embodiments, the first network device obtains the fifth response message specified by a protocol.

In some embodiments, the first network device obtains the fifth response message from a higher layer.

In some embodiments, the first network device performs processing to obtain the fifth response message.

In some embodiments, step S4101 may be omitted, and the first network device autonomously implements the function indicated by the fifth response message, or the above function is default or by default.

In step S4104, a PLMN is determined.

Regarding an optional implementation of step S4104, reference can be made to the optional implementations of step S2112 in FIG. 2 and other related parts in the embodiments involved in FIG. 2, and repeated descriptions will be omitted here.

In some embodiments, the first network device determines the PLMN where the second terminal is located.

In some embodiments, the first network device determines a second network device in the PLMN where the second terminal is located.

In some embodiments, the first network device determines the PLMN where the second terminal is located and/or the second network device in the PLMN based on the first identity information.

In some embodiments, the first network device determines, based on the first identity information, the PLMN where the second terminal is located and/or the second network device in the PLMN in a case that the first terminal is authorized to perform the ranging/SL positioning service.

In step S4105, a second request message is sent.

Regarding an optional implementation of step S4105, reference can be made to the optional implementations of step S2113 in FIG. 2 and other related parts in the embodiments involved in FIG. 2, and repeated descriptions will be omitted here.

In some embodiments, the first network device sends the second request message to the second network device, but the present disclosure is not limited to this. The second request message may also be sent to other entities.

In some embodiments, after determining the second network device in the PLMN, the first network device sends the second request message to the second network device.

Optionally, the second request message is used to request a key.

In step S4106, a second response message is obtained.

Regarding an optional implementation of step S4106, reference can be made to the optional implementations of step S2114 in FIG. 2 and other related parts in the embodiments involved in FIG. 2, and repeated descriptions will be omitted here.

In some embodiments, the first network device receives the second response message sent from the second network device, but the present disclosure is not limited to this. The first network device may also receive the second response message sent from other entities.

In some embodiments, the first network device obtains the second response message specified by a protocol.

In some embodiments, the first network device obtains the second response message from a higher layer.

In some embodiments, the first network device performs processing to obtain the second response message.

In some embodiments, step S4103 may be omitted, and the first network device autonomously implements the function indicated by the second response message, or the above function is the default or by default.

In step S4107, a first response message is sent.

Regarding an optional implementation of step S4107, reference can be made to the optional implementations of step S2115 in FIG. 2 and other related parts in the embodiments involved in FIG. 2, and repeated descriptions will be omitted here.

In some embodiments, the first network device sends the first response message to the first terminal, but the present disclosure is not limited to this. The first response message may also be sent to other entities.

In some embodiments, steps S4102 and S4103 may be omitted.

In some embodiments, step S4102 and step S4103 may be optional, and one or more of these steps may be omitted or replaced in different embodiments.

In some embodiments, step S4102, step S4103, step S4105, step S4106, and step S4107 may be optional, and one or more of these steps may be omitted or replaced in different embodiments.

FIG. 4B is a schematic flowchart of an information processing method according to an embodiment of the present disclosure. As shown in FIG. 4B, the embodiment of the present disclosure relates to an information processing method. The method is performed by a first network device. The method includes the following steps.

In step S4201, a first request message is received.

Regarding an optional implementation of step S4201, reference can be made to optional implementations of step S2107 in FIG. 2 or step S4101 in FIG. 4A, and other related parts in the embodiments involved in FIG. 2 and FIG. 4A, and repeated descriptions will be omitted here.

Optionally, the first request message includes: identity information of a first terminal, first identity information, and a service identity of a ranging/sidelink (SL) positioning service. The first identity information is used to indicate a Public Land Mobile Network (PLMN) where a second terminal is located. The first request message is used to request a key for protecting a broadcast message and/or a groupcast message of the ranging/SL positioning service.

In some embodiments, the first identity information includes one of: a PLMN identity of the second terminal, a second identity including the PLMN identity, an anonymous identity including the PLMN identity, or a random identity including a random number and the PLMN identity.

In some embodiments, the method further includes: determining, based on the first identity information, that a network device corresponding to the second terminal is the second network device.

In some embodiments, determining that the network device corresponding to the second terminal is the second network device based on the first identity information includes, in a case that the first terminal is authorized to perform the ranging/SL positioning service, determining that the network device corresponding to the second terminal is the second network device based on the first identity information.

In some embodiments, the method further includes: sending a second request message to the second network device, where the second request message includes the identity information of the first terminal and the service identity, and the second request message is used to request the key In some embodiments, the method further includes: receiving a second response message sent from the second network device, where the second response message includes the key.

In some embodiments, the method further includes: sending a first response message to the first terminal, where the first response message includes the key.

The above embodiments may be implemented individually or in combination with each other. For optional implementations, reference can be made to the optional implementations of the steps in FIG. 2 and FIG. 4A, and repeated descriptions will be omitted here.

FIG. 4C is a schematic flowchart of an information processing method according to an embodiment of the present disclosure. As shown in FIG. 4C, the embodiment of the present disclosure relates to an information processing method. The method is performed by a first network device. The method includes the following steps.

In step S4301, a PLMN is determined.

Regarding an optional implementation of step S3301, reference can be made to optional implementations of step S2112 in FIG. 2 or step S4104 in FIG. 4A, and other related parts in the embodiments involved in FIG. 2 and FIG. 4A, and repeated descriptions will be omitted here.

In step S4302, a second request message is sent.

Regarding an optional implementation of step S4302, reference can be made to optional implementations of step S2113 in FIG. 2 or step S4105 in FIG. 4A, and other related parts in the embodiments involved in FIG. 2 and FIG. 4A, and repeated descriptions will be omitted here.

The above embodiments may be implemented individually or in combination with each other. For optional implementations, reference can be made to the optional implementations of the steps in FIG. 2 and FIG. 4A, and repeated descriptions will be omitted here.

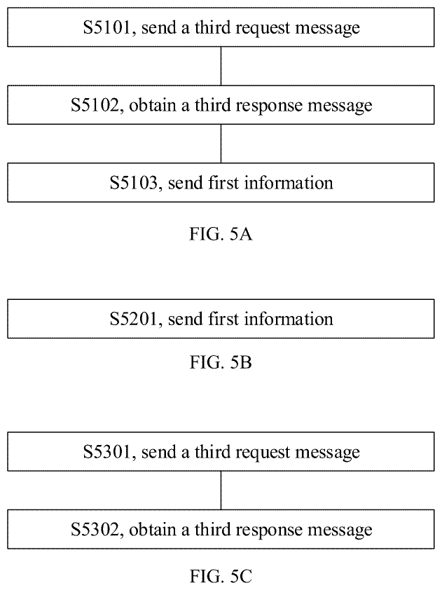

FIG. 5A is a schematic flowchart of an information processing method according to an embodiment of the present disclosure. As shown in FIG. 5A, the embodiment of the present disclosure relates to an information processing method. The method is performed by a second terminal. The method includes the following steps.

In step S5101, a third request message is sent.

Regarding an optional implementation of step S5101, reference can be made to the optional implementations of step S2101 in FIG. 2 and other related parts in the embodiments involved in FIG. 2, and repeated descriptions will be omitted here.

In some embodiments, the second terminal sends the third request message to a second network device, but the present disclosure is not limited to this. The third request message may also be sent to other entities.

Optionally, the third request message is used to request a key.

In step S5102, a third response message is obtained.

Regarding an optional implementation of step S5102, reference can be made to the optional implementations of step S2106 in FIG. 2 and other related parts in the embodiments involved in FIG. 2, and repeated descriptions will be omitted here.

In some embodiments, the second terminal receives the third response message sent from the second network device, but the present disclosure is not limited to this. The second terminal may also receive the third response message sent from other entities.

In some embodiments, the second terminal obtains the third response message specified by a protocol.

In some embodiments, the second terminal obtains the third response message from a higher layer.

In some embodiments, the second terminal performs processing to obtain the third response message.

In some embodiments, step S5102 may be omitted, and the second terminal autonomously implements the function indicated by the third response message, or the above function is the default or by default.

In step S5103, the first information is sent.

Regarding an optional implementation of step S5103, reference can be made to the optional implementations of step S2107 in FIG. 2 and other related parts in the embodiments involved in FIG. 2, and repeated descriptions will be omitted here.

In some embodiments, the second terminal broadcasts the first information, or the second terminal groupcasts the first information.

In some embodiments, the second terminal sends the first information to the first terminal, but the present disclosure is not limited to this. The first information may also be sent to other entities.

Optionally, the first information is used to determine the first request message.

In some embodiments, steps S5101 and S5102 may be omitted.

In some embodiments, step S5101 and step S5102 may be optional, and one or more of these steps may be omitted or replaced in different embodiments.

In some embodiments, step S5103 may be optional, and one or more of these steps may be omitted or replaced in different embodiments.

FIG. 5B is a schematic flowchart of an information processing method according to an embodiment of the present disclosure. As shown in FIG. 5B, the embodiment of the present disclosure relates to an information processing method. The method is performed by a second terminal. The method includes the following steps.

In step S5201, the first information is sent.

Regarding an optional implementation of step S5201, reference can be made to the optional implementations of step S2107 in FIG. 2 or step S5103 in FIG. 5A, and other related parts in the embodiments involved in FIG. 2 and FIG. 5A, and repeated descriptions will be omitted here.

Optionally, the first information includes: first identity information, a service identity, and second information. The second information is a broadcast message and/or groupcast message protected using a key. The first identity information is used to indicate a Public Land Mobile Network (PLMN) where a second terminal is located.

In some embodiments, the first identity information is used to determine a second network device in the PLMN.

In some embodiments, the first identity information includes one of: a PLMN identity of the second terminal, a second identity including the PLMN identity, an anonymous identity including the PLMN identity, and a random identity including a random number and the PLMN identity.

In some embodiments, before sending the first information, the method further includes: sending a third request message to a second network device, where the third request message includes identity information of the second terminal and a service identity, and the third request message is used to request a key; and receiving a third response message sent from the second network device, where the third response message includes the key.

In some embodiments, the third request message includes at least one of: second indication information used to indicate that the second terminal serves as a receiver of the broadcast message and/or the groupcast message; or a second group identity used to indicate a group to which the second terminal belongs.

The above embodiments may be implemented individually or in combination with each other. For optional implementations, reference can be made to the optional implementations of the steps in FIG. 2 and FIG. 5A, and repeated descriptions will be omitted here.

FIG. 5C is a schematic flowchart of an information processing method according to an embodiment of the present disclosure. As shown in FIG. 5C, the embodiment of the present disclosure relates to an information processing method. The method is performed by a second terminal. The method includes the following steps.

In step S5301, a third request message is sent.

Regarding an optional implementation of step S5301, reference can be made to the optional implementations of step S2101 in FIG. 2 or step S5101 in FIG. 5A, and other related parts in the embodiments involved in FIG. 2 and FIG. 5A, and repeated descriptions will be omitted here.

In step S5302, a third response message is obtained.

Regarding an optional implementation of step S5302, reference can be made to optional implementations of step S2106 in FIG. 2 or step S5102 in FIG. 5A, and other related parts in the embodiments involved in FIG. 2 and FIG. 5A, and repeated descriptions will be omitted here.

The above embodiments may be implemented individually or in combination with each other. For optional implementations, reference can be made to the optional implementations of the steps in FIG. 2 and FIG. 5A, and repeated descriptions will be omitted here.

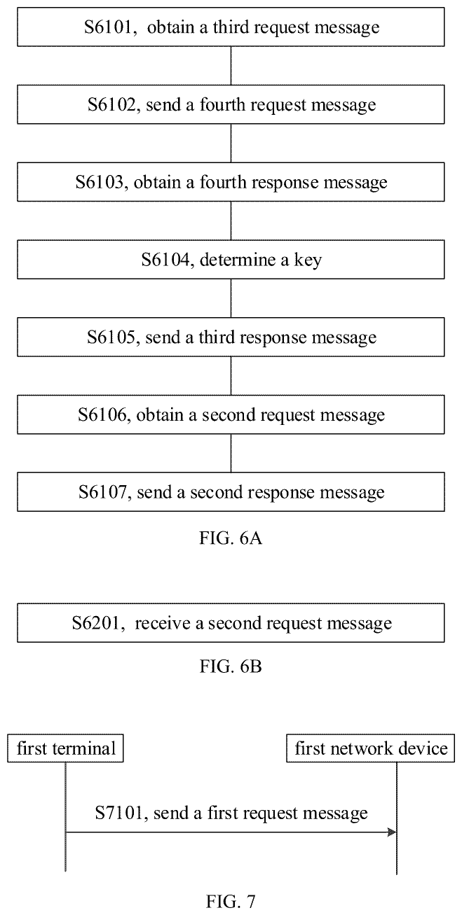

FIG. 6A is a schematic flowchart of an information processing method according to an embodiment of the present disclosure. As shown in FIG. 6A, the embodiment of the present disclosure relates to an information processing method. The method is performed by a second network device. The method includes the following steps.

In step S6101, a third request message is obtained.

Regarding an optional implementation of step S6101, reference can be made to the optional implementations of step S2101 in FIG. 2 and other related parts in the embodiments involved in FIG. 2, and repeated descriptions will be omitted here.

In some embodiments, the second network device receives the third request message sent from a second terminal, but the present disclosure is not limited to this. The second network device may also receive the third request message sent from other entities.

In some embodiments, the second network device obtains the third request message specified by a protocol.

In some embodiments, the second network device obtains the third request message from a higher layer.

In some embodiments, the second network device performs processing to obtain the third request message.

In some embodiments, step S6101 may be omitted, and the second network device autonomously implements the function indicated by the third request message, or the above function is the default or by default.

Optionally, the third request message is used for the second network device to determine a fourth request message.

In step S6102, a fourth request message is sent.

Regarding an optional implementation of step S6102, reference can be made to the optional implementations of step S2102 in FIG. 2 and other related parts in the embodiments involved in FIG. 2, and repeated descriptions will be omitted here.

In some embodiments, the second network device sends the fourth request message to the UDM or APP server, but the present disclosure is not limited to this. The fourth request message may also be sent to other entities.

Optionally, the fourth request message is used to request authorization of the second terminal.

In step S6103, a fourth response message is obtained.

Regarding an optional implementation of step S6103, reference can be made to the optional implementations of step S2104 in FIG. 2 and other related parts in the embodiments involved in FIG. 2, and repeated descriptions will be omitted here.

In some embodiments, the second network device receives the fourth response message sent from the UDM or APP server, but the present disclosure is not limited to this. The second network device may also receive the fourth response message sent from other entities.

In some embodiments, the second network device obtains the fourth response message specified by a protocol.

In some embodiments, the second network device obtains the fourth response message from a higher layer.

In some embodiments, the second network device performs processing to obtain the fourth response message.

In some embodiments, step S6103 may be omitted, and the second network device autonomously implements the function indicated by the fourth response message, or the above function is the default or by default.

In step S6104, a key is determined.

In some embodiments, the second network device determines the key in a case where the first terminal is authorized to perform the ranging/SL positioning service.

In some embodiments, the second network device determines the key based on the service identity.

In some embodiments, the second network device determines the key based on the service identity and the random number.

In some embodiments, the second network device determines the key and/or a validity period of the key based on the service identity, the random number, and a validity period.

In step S6105, a third response message is sent.

Regarding an optional implementation of step S6105, reference can be made to the optional implementations of step S2106 in FIG. 2 and other related parts in the embodiments involved in FIG. 2, and repeated descriptions will be omitted here.

In some embodiments, the second network device sends the third response message to the second terminal, but the present disclosure is not limited to this. The third response message may also be sent to other entities.

In step S6106, a second request message is obtained.

Regarding an optional implementation of step S6106, reference can be made to the optional implementations of step S2113 in FIG. 2 and other related parts in the embodiments involved in FIG. 2, and repeated descriptions will be omitted here.

In some embodiments, the second network device receives the second request message sent from the first network device, but the present disclosure is not limited to this. The second network device may also receive the second request message sent from other entities.

In some embodiments, the second network device obtains the second request message specified by a protocol.

In some embodiments, the second network device obtains the second request message from a higher layer.

In some embodiments, the second network device performs processing to obtain the second request message.

In some embodiments, step S6106 may be omitted, and the second network device autonomously implements the function indicated by the second request message, or the above function is default or by default.

Optionally, the second request message is used for the second network device to determine a second response message.

In step S6107, a second response message is sent.

Regarding an optional implementation of step S6107, reference can be made to the optional implementation of step S2114 in FIG. 2 and other related parts in the embodiments involved in FIG. 2, and repeated descriptions will be omitted here.

In some embodiments, the second network device sends the second response message to the first network device, but the present disclosure is not limited to this. The second response message may also be sent to other entities.

In some embodiments, step S6101, step S6102, step S6103, and step S6104 may be omitted.

In some embodiments, step S6101, step S6102, step S6103, and step S6105 may be optional, and one or more of these steps may be omitted or replaced in different embodiments.

In some embodiments, step S6104 may be optional, and one or more of these steps may be omitted or replaced in different embodiments.

In some embodiments, step S6106 and step S6107 may be optional, and one or more of these steps may be omitted or replaced in different embodiments.

FIG. 6B is a schematic flowchart of an information processing method according to an embodiment of the present disclosure. As shown in FIG. 6B, the embodiment of the present disclosure relates to an information processing method. The method is performed by a second network device. The method includes the following steps.

In step S6201, a second request message is received.

Regarding an optional implementation of step S5601, reference can be made to optional implementations of step S2113 in FIG. 2 or step S6106 in FIG. 6A, and other related parts in the embodiments involved in FIG. 2 and FIG. 6A, and repeated descriptions will be omitted here.

Optionally, the second request message includes identity information of the first terminal and a service identity of a ranging/sidelink (SL) positioning service, and the second request is used to request a key.

In some embodiments, the second network device sends a second response message to the first network device, where the second response message includes the key.

In some embodiments, before receiving the second request message sent from the first network device, the method further includes: receiving a third request message sent from a second terminal, where the third request message includes identity information of the second terminal and a service identity, and the third request message is used to request a key; and sending a third response message to the second terminal, where the third response message includes the key.

In some embodiments, the method further includes: determining the key in a case that the second terminal is authorized to perform the ranging/SL positioning service.

The above embodiments may be implemented individually or in combination with each other. For optional implementations, reference can be made to the optional implementations of the steps in FIG. 2 and FIG. 5A, and repeated descriptions will be omitted here.

FIG. 7 is a schematic flowchart of an information processing method according to an embodiment of the present disclosure. As shown in FIG. 7, the embodiment of the present disclosure relates to an information processing method applied in a communication system. The method includes the following steps.

In step S7101, a first terminal sends a first request message to a first network device.

Regarding an optional implementation of step S7101, reference can be made to optional implementations of step S2108 of FIG. 2, step S3102 of FIG. 3A, step S4101 in FIG. 4A, and other related parts in the embodiments involved in FIG. 2, FIG. 3A, and FIG. 4A, and repeated descriptions will be omitted here.

Optionally, the first request message includes: identity information of the first terminal, first identity information, and a service identity of a ranging/sidelink (SL) positioning service. The first identity information is used to indicate a Public Land Mobile Network (PLMN) where a second terminal is located. The first request message is used to request a key for protecting a broadcast message and/or a groupcast message of the ranging/SL positioning service.

In some embodiments, the first network device determines, based on the first identity information, that a network device corresponding to the second terminal is the second network device; and the first network device sends a second request message to a second network device, where the second request message includes the identity information of the first terminal and the service identity, and the second request message is used to request the key.

In some embodiments, the second network device sends a second response message to the first network device, and the second response message includes the key.

In some embodiments, the first network device sends a first response message to the first terminal, and the first response message includes the key.

In some embodiments, before the first terminal sends the first request message to the first network device, the method includes: sending, by the second terminal, first information to the first terminal, where the first information includes: the first identity information, the service identity, and second information, and the second information is the broadcast message and/or groupcast message protected using the key.

In some embodiments, the above method may include the methods described in the above-mentioned embodiments at the information processing system 100 side, at the network device side, at the terminal side, etc., and repeated descriptions will be omitted here.

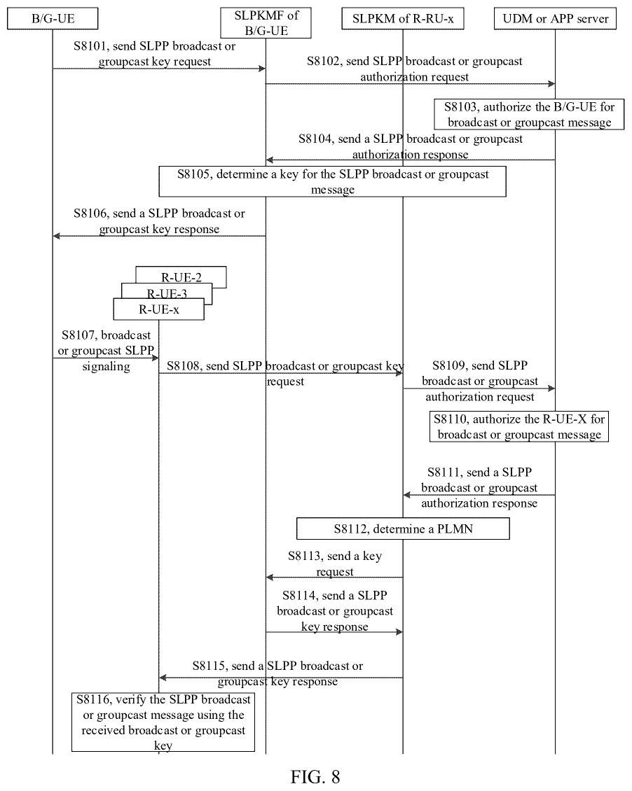

FIG. 8 is a schematic flowchart of an information processing method according to an embodiment of the present disclosure. As shown in FIG. 8, the embodiment of the present disclosure relates to an information processing method. The method includes the following steps.

In step S8101, a B/G-UE sends an SLPP broadcast or groupcast key request to a positioning key proximity service key management function (SLPKMF) of the B/G-UE.

Optionally, a UE intending to broadcast or groupcast SLPP signaling (B/G-UE) sends the key request message to its SLPKMF. The key request message includes at least a B/G-UE identity (ID), a service identity for which the broadcast or groupcast is performed, an indicator of the UE as a broadcaster or groupcaster, and optionally a group identity.

In some embodiments, the B/G-UE is the second terminal in the previous embodiments, and/or the SLPKMF of the B/G-UE is the second network device in the previous embodiments. The B/G-UE identity is the identity information of the second terminal in the previous embodiments, and/or the service identity for which the broadcast or groupcast is performed is the service identity of the ranging/SL positioning service in the previous embodiments. The indicator of the broadcaster or groupcaster is the second indication information in the previous embodiments, and/or the group identity is the second group identity in the previous embodiments. The SLPP broadcast or groupcast key request is the third request message in the previous embodiments, and/or the key request message is the third request message in the previous embodiments.

In steps S8102 to S8104, the SLPKMF of the B/G-UE checks with the UDM or APP application server whether the B/G-UE is authorized to perform broadcasting or groupcasting of the SLPP signaling for the ranging/SL positioning service indicated by the service identity.

In step S8102, the SLPKMF of the B/G-UE sends an SLPP broadcast or groupcast authorization request to the UDM or APP server.

Optionally, the SLPP broadcast or groupcast authorization request includes the B/G-UE identity, an indicator of the UE as a broadcaster or groupcaster, and the service identity.

In some embodiments, the SLPP broadcast or groupcast authorization request is the fourth request message in the previous embodiments.

In step S8103, the UDM or APP server authorizes the B/G-UE to broadcast or groupcast message(s).

In step S8104, the UDM or APP server sends an SLPP broadcast or groupcast authorization response to the SLPKM of the B/G-UE.

In some embodiments, the SLPP broadcast or groupcast authorization response is the fourth response message in the previous embodiments.

In step S8105, the SLPKM of the B/G-UE determines a key for the SLPP broadcast or groupcast message(s).

Optionally, the SLPKM of the B/G-UE generates a key for the SLPP broadcast or groupcast message(s) by associating the key with the service identity.

In step S8106, the SLPKM of the B/G-UE sends an SLPP broadcast or groupcast key response to the B/G-UE.

In step S8107, the B/G-UE broadcasts or groupcasts SLPP signaling.

Optionally, the broadcast message or groupcast message includes a B/G-UE identity, which is presented in the form of anonymous@PLMN-ID, the service ID, optionally the group identity, and the SLPP signaling.

In some embodiments, the SLPP signaling is the first information or the SLPP broadcast or groupcast message in the previous embodiments. The group identity is the first group identity in the previous embodiments. The B/G-UE identity, which is presented in the form of anonymous@PLMN-ID is the first identity information in the previous embodiments.

In step S8108, a R-UE-x sends an SLPP broadcast or groupcast key request to the SLPKM of the R-UE-x.

Optionally, when the R-UE-x receives the SLPP broadcast or groupcast message from the B/G-UE, the R-UE-x intends to decode the protected SLPP broadcast or groupcast message and sends the SLPP broadcast or groupcast key request to the SLPKM of the R-UE-x. The SLPP broadcast or groupcast key request includes an R-UE-x identity, the B/G-UE identity, which is presented in the form of anonymous@PLMN-ID, the service identity, an indicator of the UE as a receiver, and optionally a group identity.

In some embodiments, the R-UE-x is the first terminal in the previous embodiments, and/or the SLPKM of the R-UEx is the first network device in the previous embodiments. The R-UE-x identity is the identity information of the first terminal in the previous embodiments. The SLPP broadcast or groupcast key request is the first request message in the previous embodiments. The indicator of the UE as a receiver is the first indication information in the previous embodiments. The group identity is the first group identity in the previous embodiments.

In some embodiments, the R-UEx includes at least one of R-UE-1, R-UE-2, or R-UE-3, etc.

In steps S8109 to S8111, the SLPKM of the R-UE-x checks with the UDM or APP server whether the R-UE-x is authorized to receive the SLPP signaling for the ranging/SL positioning service indicated by the service identity.

In step S8109, the B/G-UE sends an SLPP broadcast or groupcast authorization request to the SLPKMF of the R-UE-x.

Optionally, the SLPP broadcast or groupcast authorization request includes the R-UE-x identity, the indicator of the UE as a receiver, and a service identity.

In some embodiments, the SLPP broadcast or groupcast authorization request is the fifth request message in the previous embodiments.

In step S8110, the UDM or APP server authorizes the R-UE-x for a broadcast or groupcast message.

In step S8111, the UDM or APP server sends an SLPP broadcast or groupcast authorization response to the SLPKM of the R-UE-x.

In some embodiments, the SLPP broadcast or groupcast authorization response is the fifth response message in the previous embodiments.

In step S8112, the SLPKMF of the R-UE-x determines a PLMN.

Optionally, if R-UE-x is authorized successfully, the SLPKMF of the R-UE-x determines the SLPKMF of the associated B/G-UE based on the anonymous@PLMN-ID of the B/G-UE received from the R-UE-x, where the PLMN-ID indicates the HPLMN of the B/G-UE.

In step S8113, the SLPKMF of the R-UE-x sends a key request to the SLPKMF of the B/G-UE.

Optionally, if the B/G-UE and R-UE-x are served by the same SLPKMF, step S8113 may be skipped.

Optionally, the key request includes at least the R-UE-x identity, the service identity, and optionally a group identity.

In some embodiments, the key request is the second request message in the previous embodiments. The group identity may be the first group identity in the previous embodiments.

In step S8114, the SLPKMF of the B/G-UE sends an SLPP broadcast or groupcast key response to the SLPKMF of the R-UE-x.

Optionally, if the B/G-UE and R-UE-x are served by the same SLPKMF, step S8114 may be skipped.

In some embodiments, the SLPP broadcast or groupcast key response is the second response message in the previous embodiments.

In step S8115, the SLPKMF of the R-UE-x sends an SLPP broadcast or groupcast key response to the R-UE-x.

In some embodiments, the SLPP broadcast or groupcast key response is the first response message in the previous embodiments.

In step S8116, the R-UE-x verifies the SLPP broadcast or groupcast message using the received broadcast or groupcast key.

In some embodiments, the broadcast or groupcast key is the key in the previous embodiments; the SLPP broadcast or groupcast message is the second information in the previous embodiments.

The information processing method involved in the embodiments of the present disclosure may include at least one of steps S8101 to S8116. For example, step S8112 may be implemented as an independent embodiment. A combination of step S8111 and step S8112 may be implemented as an independent embodiment. A combination of steps S8111, S8113, and S8114 may be implemented as an independent embodiment. A combination of steps S8109, S8110, S8111, and S8112 may be implemented as an independent embodiment. Step S8118 may be implemented as an independent embodiment. A combination of step S8117 and step S8118 may be implemented as an independent embodiment. A combination of steps S8118 to S8115 may be implemented as an independent embodiment. A combination of steps S8117 to S8115 may be implemented as an independent embodiment. A combination of steps S81101 to S8116 may be implemented as an independent embodiment. A combination of steps S8112 to S8114 may be implemented as an independent embodiment. A combination of steps S8101 to S8115 may be implemented as an independent embodiment. A combination of steps S8101 to S8116 may be implemented as an independent embodiment.

In some embodiments, at least one of steps S8101 to S8106 or step S8116 may be omitted.

In some embodiments, steps S8101 to S8106 may be optional, and one or more of these steps may be omitted or replaced in different embodiments.

In some embodiments, step S8116 may be optional, and one or more of these steps may be omitted or replaced in different embodiments.

In an embodiment of the present disclosure, a part or all of the steps and their optional implementations may be arbitrarily combined with a part or all of the steps in other embodiments, and may also be arbitrarily combined with optional implementations of other embodiments.

The embodiments of the present disclosure further provide an apparatus for implementing any of the above methods. For example, an apparatus is provided, including unit(s) for implementing each step performed by a terminal in any of the above methods. For another example, another apparatus is provided, including unit(s) for implementing each step performed by a network device in any of the above methods.

It can be understood that the division of the units in the above apparatus is merely a division of logical functions. In actual implementation, the units may be fully or partially integrated into a single physical entity, or the units may be physically separated. Furthermore, the units in the apparatus may be implemented in the form of a processor invoking software. For example, the apparatus includes a processor connected to a memory storing computer instructions, and the processor invokes the computer instructions stored in the memory to implement any of the above methods or the functions of various units in the apparatus. The processor may be, for example, a general-purpose processor such as a Central Processing Unit (CPU) or a microprocessor, and the memory may be internal in the apparatus or may be external to the apparatus. Alternatively, the units in the apparatus may be implemented in the form of hardware circuits, and the functions of a part or all of the units may be implemented by designing the hardware circuits. The hardware circuits may be understood as one or more processors. For example, in an implementation, the hardware circuits may be an Application-Specific Integrated Circuit (ASIC), and the functions of a part or all of the units may be implemented by designing logical relationships between components within the circuits. For another example, in another implementation, the hardware circuits may be implemented by Programmable Logic Devices (PLDs). For example, a Field Programmable Gate Array (FPGA) may include a large number of logic gate circuits, and connection relationships between the logic gate circuits may be configured through a configuration file, thereby implementing the above functions of a part or all of the units. All the units of the above apparatus may be realized by invoking software through the processor; or, all the units of the above apparatus may be realized through the form of hardware circuit(s); or, a part of the units of the above apparatus may be realized by invoking software through the processor, and the remaining units of the above apparatus may be realized through the form of hardware circuit(s).

In the embodiments of the present disclosure, the processor is a circuit with signal processing capabilities. In an implementation, the processor may be a circuit with instruction reading and execution capabilities, such as a Central Processing Unit (CPU), a microprocessor, a graphics processing unit (GPU) (which may be understood as a microprocessor), or a digital signal processor (DSP), etc. In another implementation, the processor may implement certain functions through logical relationships of hardware circuits. The logical relationships of the hardware circuits are fixed or reconfigurable. For example, the processor may be a hardware circuit implemented with an Application-Specific Integrated Circuit (ASIC) or a Programmable Logic Device (PLD), such as an FPGA. In a reconfigurable hardware circuit, the process of loading a configuration file on the processor to implement a hardware circuit configuration may be understood as a process of the processor being loaded with instructions to implement the functions of a part or all of the above units. Furthermore, the processor may also be a hardware circuit designed for artificial intelligence, which may be understood as an ASIC, such as a Neural Network Processing Unit (NPU) or a Tensor Processing Unit (TPU), a Deep Learning Processing Unit (DPU), etc.

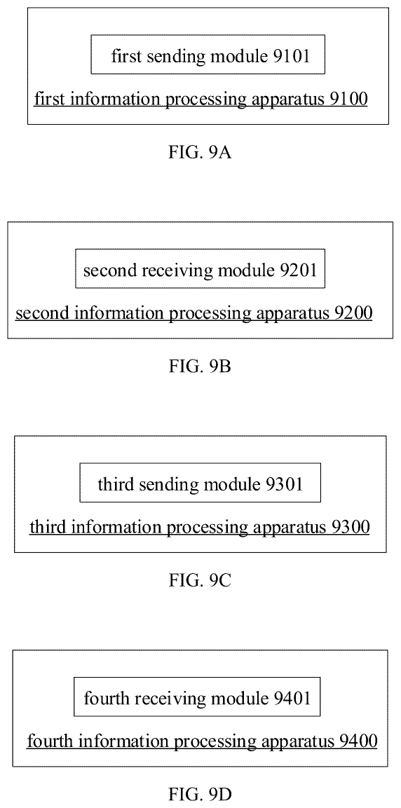

FIG. 9A is a schematic diagram of the structure of a first information processing apparatus according to an embodiment of the present disclosure. As shown in FIG. 9A, the first information processing apparatus 9100 includes: a first sending module 9101 configured to send a first request message to a first network device. Optionally, the first sending module 9101 is used to execute the steps related to sending performed by the first terminal in any of the above methods, which are not repeated here. Optionally, the first information processing apparatus 9100 further includes a first receiving module. The first receiving module is used to execute the steps related to receiving performed by the first terminal in any of the above methods, which are not repeated here.

FIG. 9B is a schematic diagram of the structure of a second information processing apparatus according to an embodiment of the present disclosure. As shown in FIG. 9B, the second information processing apparatus 9200 includes: a second receiving module 9201 configured to receive a first request message. Optionally, the second receiving module 9201 is used to execute the steps related to receiving performed by the first network device in any of the above methods, which will not be repeated here. Optionally, the second information processing apparatus 9200 also includes a second sending module. The second sending module is used to execute the steps related to sending performed by the first network device in any of the above methods, which are not repeated here. Optionally, the second information processing apparatus 9200 further includes a first processing module. The first processing module is used to execute the steps related to processing performed by the first network device in any of the above methods, which are not repeated here.

FIG. 9C is a schematic diagram of the structure of a third information processing apparatus according to an embodiment of the present disclosure. As shown in FIG. 9C, the third information processing apparatus 9300 includes: a third sending module 9301 configured to send first information. Optionally, the third sending module 9301 is used to execute the steps related to sending performed by the second terminal in any of the above methods, which are not repeated here. Optionally, the third information processing apparatus 9300 further includes a third receiving module. The third receiving module is used to execute the steps related to receiving performed by the second terminal in any of the above methods, which are not repeated here.

FIG. 9D is a schematic diagram of the structure of a fourth information processing apparatus according to an embodiment of the present disclosure. As shown in FIG. 9D, the fourth information processing apparatus 9400 includes: a fourth receiving module 9401 configured to receive a second request message sent from a first network device. Optionally, the fourth receiving module 9401 is used to execute the steps related to receiving performed by the second network device in any of the above methods, which are not repeated here. Optionally, the fourth information processing apparatus 9400 further includes a fourth sending module. The fourth sending module is used to execute the steps related to sending performed by the second network device in any of the above methods, which are not repeated here. Optionally, the fourth information processing apparatus 9400 further includes a second processing module. The second processing module is used to execute the steps related to processing performed by the second network device in any of the above methods, which are not repeated here.

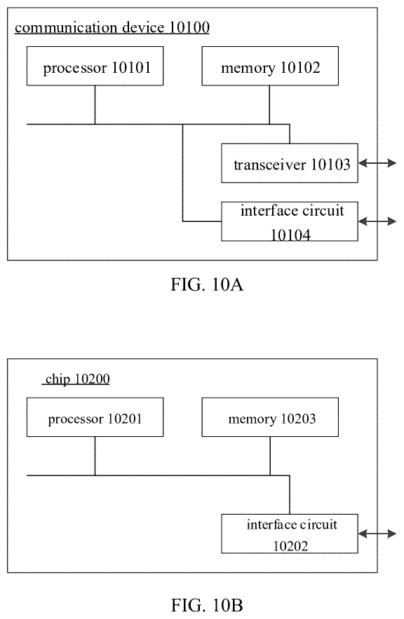

FIG. 10A is a schematic diagram of the structure of a communication device 10100 according to an embodiment of the present disclosure. The communication device 10100 may be a network device (e.g., an access network device, a core network device, etc.), or may be a terminal (e.g., user equipment, etc.), or may be a chip, chip system, or processor, etc. that supports a network device to implement any of the above methods, or may be a chip, chip system, or processor, etc. that supports a terminal to implement any of the above methods. The communication device 10100 may be used to implement the methods described in the above method embodiments. For details, reference can be made to the description of the above method embodiments.

As shown in FIG. 10A, the communication device 10100 includes one or more processors 10101. The processor 10101 may be a general-purpose processor or a dedicated processor, etc., such as a baseband processor or a central processing unit. A baseband processor may be used to process communication protocol(s) and communication data, and a central processing unit may be used to control a communication apparatus (e.g., a base station, baseband chip, terminal device, terminal device chip, DU or CU, etc.), execute programs, and process program data. The processor 10101 is used to invoke instructions to cause the communication device 10100 to perform any of the above methods.

In some embodiments, the communication device 10100 further includes one or more memories 10102 for storing instructions. Optionally, all or part of the memories 10102 may be located outside the communication device 10100.

In some embodiments, the communication device 10100 further includes one or more transceivers 10103. When the communication device 10100 includes one or more transceivers 10103, the communication steps, such as sending and receiving, etc., in the above methods are performed by the transceivers 10103, and the other steps are performed by the processors 10101.

In some embodiments, a transceiver may include a receiver and a transmitter, which may be separate or integrated. Optionally, the terms transceiver, transceiving unit, transceiving device, and transceiving circuit, etc., may be used interchangeably; the terms transmitter, transmitting unit, transmitting device, and transmitting circuit, etc., may be used interchangeably; and the terms receiver, receiving unit, receiving device, and receiving circuit, etc., may be used interchangeably.

Optionally, the communication device 10100 further includes one or more interface circuits 10104, which are connected to the memory 10102. The interface circuits 10104 may be used to receive signals from the memory 10102 or other apparatuses, and may be used to send signals to the memory 10102 or other apparatuses. For example, the interface circuits 10104 may read instructions stored in the memory 10102 and send the instructions to the processor 10101.

The communication device 10100 described in the above embodiments may be a network device or a terminal, but the scope of the communication device 10100 described in the present disclosure is not limited thereto, and the structure of the communication device 10100 may not be limited to FIG. 10A. The communication device may be an independent device or may be a part of a larger device. For example, the communication device may be: (1) an independent integrated circuit IC, or a chip, or a chip system or subsystem; (2) a collection of one or more ICs, optionally, the IC collection may also include a storage component for storing data or computer programs; (3) an ASIC, such as a modem; (4) a module that can be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc. ; (6) others, etc.

FIG. 10B is a schematic diagram of the structure of a chip 10200 according to an embodiment of the present disclosure. For a case where the communication device 10100 may be a chip or a chip system, reference can be made to the schematic diagram of the structure of the chip 10200 shown in FIG. 10B, but the present disclosure is not limited to this.

The chip 10200 includes one or more processors 10201, and the processor 10201 is used to invoke computer instructions to cause the chip 10200 to perform any of the above methods.

In some embodiments, the chip 10200 further includes one or more interface circuits 10202, which are connected to the memory 10203. The interface circuit 10202 may be used to receive signals from the memory 10203 or other apparatuses, and may be used to send signals to the memory 10203 or other apparatuses. For example, the interface circuit 10202 may read instructions stored in the memory 10203 and send the instructions to the processor 10201. Optionally, the terms such as interface circuit, interface, transceiving pin, transceiver, etc., may be used interchangeably.

In some embodiments, the chip 10200 further includes one or more memories 10203 for storing computer instructions. Optionally, all or part of the memories 10203 may be outside the chip 10200.

The present disclosure also provides a storage medium, and instructions are stored in the storage medium. When the instructions are run on the communication device 10100, the communication device 10100 is caused to perform any of the above methods. Optionally, the storage medium is an electronic storage medium. Optionally, the storage medium is a computer-readable storage medium, but is not limited to this and may also be a storage medium readable by other apparatuses. Optionally, the storage medium may be a non-transitory storage medium, but is not limited to this and may also be a transitory storage medium.

The present disclosure further provides a program product. When the program product is executed by the communication device 10100, the communication device 10100 is caused to perform any of the above methods. Optionally, the program product is a computer program product.

The present disclosure further proposes a computer program. When the computer program is run on a computer, the computer is caused to perform any one of the above methods.

1. An information processing method, performed by a first terminal, the method comprising:
sending a first request message to a first network device, wherein the first request message comprises: identity information of the first terminal, first identity information and a service identity of a ranging/sidelink (SL) positioning service, and the first identity information is used to indicate a Public Land Mobile Network (PLMN) where a second terminal is located;
wherein the first request message is used to request a key for protecting at least one of a broadcast message or a groupcast message of the ranging/SL positioning service.

2. The method according to claim 1, wherein the first identity information is used to determine a second network device in the PLMN.

3. The method according to claim 1, wherein before the method comprises:
receiving first information sent from the second terminal, wherein the first information comprises the first identity information, the service identity and second information, and the second information is the at least one of broadcast message or the groupcast message protected using the key.

4. The method according to claim 1, wherein the first identity information comprises one of:
a PLMN identity of the second terminal;
a second identity comprising the PLMN identity, wherein the second identity is used to identify the second terminal;
an anonymous identity comprising the PLMN identity, wherein the anonymous identity is used to identify the second terminal and is anonymous; or
a random identity comprising a random number and the PLMN identity, wherein the random identity is used to identify the second terminal.

5. The method according to claim 1, wherein the first request message comprises at least one of:
first indication information used to indicate that the first terminal serves as a receiver of at least one of the broadcast message or the groupcast message; or
a first group identity used to indicate a group to which the first terminal belongs.

6. The method according to claim 1, further comprising:
receiving a first response message sent from the first network device, wherein the first response message comprises the key.

7. An information processing method, performed by a first network device, the method comprising:
receiving a first request message sent from a first terminal, wherein the first request message comprises: identity information of the first terminal, first identity information and a service identity of a ranging/sidelink (SL) positioning service, and the first identity information is used to indicate a Public Land Mobile Network (PLMN) where a second terminal is located;
wherein the first request message is used to request a key for protecting at least one of a broadcast message or a groupcast message of the ranging/SL positioning service.

8. The method according to claim 7, wherein the first identity information comprises one of:
a PLMN identity of the second terminal;
a second identity comprising the PLMN identity, wherein the second identity is used to identify the second terminal;
an anonymous identity comprising the PLMN identity, wherein the anonymous identity is used to identify the second terminal and is anonymous; or
a random identity comprising a random number and the PLMN identity, wherein the random identity is used to identify the second terminal.

9. The method according to claim 7, further comprising:
determining that a network device corresponding to the second terminal is a second network device based on the first identity information;
wherein determining that the network device corresponding to the second terminal is the second network device based on the first identity information comprises:
in a case that the first terminal is authorized to perform the ranging/SL positioning service, determining that the network device corresponding to the second terminal is the second network device based on the first identity information.

10. (canceled)

11. The method according to claim 9, further comprising:
sending a second request message to the second network device, wherein the second request message comprises the identity information of the first terminal and the service identity, and the second request message is used to request the key.

12. The method according to claim 11, further comprising:
receiving a second response message sent from the second network device, wherein the second response message comprises the key.

13. The method according to claim 12, further comprising:
sending a first response message to the first terminal, wherein the first response message comprises the key.

14. An information processing method, performed by a second terminal, the method comprising:
sending first information, wherein the first information comprises first identity information, a service identity of a ranging/sidelink (SL) positioning service and second information, the second information is at least one of a broadcast message or groupcast message protected using a key, and the first identity information is used to indicate a Public Land Mobile Network (PLMN) where the second terminal is located.

15. The method according to claim 14, wherein the first identity information is used to determine a second network device in the PLMN.

16. The method according to claim 14, wherein the first identity information comprises one of:
a PLMN identity of the second terminal;
a second identity comprising the PLMN identity, wherein the second identity is used to identify the second terminal;
an anonymous identity comprising the PLMN identity, wherein the anonymous identity is used to identify the second terminal and is anonymous; or
a random identity comprising a random number and the PLMN identity, wherein the random identity is used to identify the second terminal.

17. The method according to claim 14, wherein the method further comprises:
sending a third request message to a second network device, wherein the third request message comprises identity information of the second terminal and the service identity, and the third request message is used to request the key; and
receiving a third response message sent from the second network device, wherein the third response message comprises the key.

18. The method according to claim 17, wherein the third request message comprises at least one of:
second indication information, wherein the second indication information is used to indicate that the second terminal serves as a receiver of at least one of the broadcast message or the groupcast message; or
a second group identity, wherein the second group identity is used to indicate a group to which the second terminal belongs.

19.-27. (canceled)

28. A communication device, comprising:
one or more processors;
wherein the one or more processors are configured to invoke instructions to cause the communication device to perform the information processing method according to claim claims

29.-30. (canceled)

31. A communication device, comprising:
one or more processors;
wherein the one or more processors are configured to invoke instructions to cause the communication device to perform the information processing method according to claim 7.

32. A communication device, comprising:
one or more processors;
wherein the one or more processors are configured to invoke instructions to cause the communication device to perform the information processing method according to claim 14.
